(19) United States
(12) Patent Application Publication
(10) Pub. No.: US 2005/0003110 A1
(43) Pub. Date: Jan. 6, 2005

(54) Alignment layer, process for producing alignment layer, substrate with alignment layer and liquid crystal dispaly

(76) Inventors: Tomio Tanaka, Tokyo (JP); Hironori Kobayashi, Tokyo (JP)

Correspondence Address: Seyfarth Shaw, Suite 4200, 55 E Monroe Street, Chicago, IL, 60603, US

(21) Appl. No.: 10/497,554

(22) PCT Filed: Feb. 17, 2003
(86) PCT No.: PCT/JP03/01664

(30) Foreign Application Priority Data
Feb. 15, 2002 (JP) 2002-39376

(51) Int. Cl. C09K 19/00

(52) U.S. Cl. 428/1.23; 428/1.2; 428/1.25; 428/1.26

(57) ABSTRACT

The present invention has a main object to provide an orientation film that enables appropriately orienting the liquid crystal without forming a structural member such as a projecting portion, etc. or without performing rubbing processing. To attain the object, the present invention provides an orientation film that has on its surface on a side where the liquid crystal layer is contacted therewith a pattern including a water-repellent region and a hydrophilic region that is a region where the angle of contact with water is smaller than that in the water-repellent region.

### TECHNICAL FIELD

The present invention relates to an orientation film that can orient a liquid crystal molecule to a direction which is suitable with respect to a relevant substrate and that is advantageous in terms of the cost and, more particularly, to an orientation film that enables, for improving the field-of-view characteristic, easily dividing the orientation direction within a relevant pixel, a substrate equipped with the orientation film, and a liquid crystal display device that uses the orientation film-equipped substrate.

### BACKGROUND ART

A liquid crystal cell is a display device that utilizes the electro-optical change of the liquid crystal. It is small in size and light in weight, as the device, and is small in power consumption, and the like. Attention has in recent years been drawn toward those characteristics of the liquid crystal cell, and it has been making a remarkable expansion and development as a display device for use as various kinds of displays. Among all, a twisted nematic type (TN type) field effect type liquid crystal cell that uses nematic liquid crystal having a positive dielectric-anisotropic property as well as a pair of electrode substrates that oppose each other is a typical one of the liquid crystal cell. Namely, in it, so-called “homogeneous orientation” is made of the liquid crystal molecule in the way that at each interface that molecule is oriented in parallel with the substrate. Further, the both substrates are combined with each other so that the directions in which the liquid crystal molecules are oriented may intersect each other at a right angle.

On the other hand, in a case of using a nematic liquid crystal having negative dielectric anisotropic property, many field effect type liquid crystal cells are known. They include a field-controlled birefringence type (ECB type) wherein so-called “homeo-tropic” orientation is made of the liquid crystal molecule in the way that at each interface of a pair of electrode substrates that oppose each other it is oriented perpendicularly to the substrate and which thereby utilizes a change in the birefringence in the liquid crystal layer that occurs when a voltage has been applied, a phase-transition type (PC type) which utilizes a change in the phase structure of the liquid crystal, and a guest/host type (GH type) in which coloring matter is mixed.

A brief explanation will now be given, using FIG. 1, of the above-described liquid crystal display device in vertical orientation mode. This vertical orientation mode is the one in which negative type liquid-crystalline material having negative dielectric constant anisotropy and an orientation film in the vertical direction are combined with each other. In that mode, as illustrated in FIG. 1A, when no voltage is applied, the liquid crystal molecule is oriented in the vertical direction, thereby a black display is given. As illustrated in FIG. 1C, when a prescribed level of voltage is applied, the liquid crystal molecule is oriented in the horizontal direction, thereby a white display is given. This vertical orientation mode has a merit in that, compared with the TN mode, contrast of the display is high and, in addition, black/white level response speed also is high.

However, in a case where a half tone display is made in the vertical orientation mode, a problem arises in that the dependency on the viewing angle of the displayed state occurs. Namely, while, in a case where a half tone is displayed in the vertical orientation mode, a lower level of voltage than at the time when a white color is displayed is applied, in this case as illustrated in FIG. 1B, the liquid crystal molecule becomes oriented in an oblique direction. In that case, as illustrated, with respect to a light that advances from the right/lower to the left/upper, the liquid crystal molecule becomes oriented in parallel. Accordingly, it results that because of the liquid crystal's exhibiting almost no birefringence effect, when viewing from the left side, the liquid crystal looks black. In contrast to this, with respect to a light that advances from the left/lower to the right/upper, the liquid crystal molecule is oriented perpendicularly. Therefore, the liquid crystal exhibits a great birefringence effect upon the incident light, thereby a display that is near to white is made. Like that, the vertical orientation mode had the problem that the dependency on the viewing angle of the displayed state occurred.

For solving the above-described problem, it is known that the viewing angle characteristic is improved by dividing the orientation direction of the liquid crystal molecule into a plurality of different directions within the pixel. Japanese Patent Application Laid-Open No. 6-301036 discloses a liquid crystal display device in vertical orientation mode, in which an opening portion is formed in each of the mutually opposing portions at the centers of the pixel electrodes of the opposing electrodes; the portions where the electric field is inclined are formed at the central parts of the pixels; and the direction in which the liquid crystal molecule is oriented is thereby divided into two, or, four, directions. However, the liquid crystal display device that is disclosed in Japanese Patent Application Laid-Open No. 6-301036 involves therein a problem that the response speed is slow. Further, it has turned out to be the case that, especially, the response speed is low at the time when a transition is made from a state where no voltage is applied to a state where a voltage is applied. It is thought that this is because the length of a region being formed within the pixel where the directions in which the liquid crystal molecules are oriented are the same is approximately half the length of the pixel, and, because, therefore, a significantly large length of time is needed until the orientation of all the liquid crystal molecules within the region is put in regular order.

On the other hand, Japanese Patent Application Laid-Open No. 7-199193 discloses the following liquid crystal display device in vertical orientation mode. In that device, by providing on the electrode inclined surfaces the inclined surfaces directions of which are different, the direction in which the liquid crystal molecule is oriented within the pixel is differentiated or divided into a plurality of directions. However, in the disclosed construction, since the inclined surfaces are provided on the entire pixel, when no voltage is applied, the liquid crystal contacting every orientation surface is oriented along the inclined surface. Therefore, it is impossible to obtain a complete display of black, with the result that the problem that the contrast becomes lowered occurred. In addition, since the inclined surfaces are provided over the entire pixel, it turned out to be the case that the inclined surface is gentle and this cannot be said enough to define the orientation direction of the liquid crystal. For making the inclined surface sharper, it is necessary to make the relevant structure greater in thickness. However, making the relevant structure of the dielectric greater in thickness results in that during the operation of the device electric charge is accumulated on the structure. It has turned out to be the case that the results in the phenomenon's called “seizure” occurring that due to the electric charge that has been accumulated thereon the direction of the liquid crystal molecule is not changed even when a voltage is applied between the electrodes.

Further, as means for solving the above-described point in problem, there is disclosed in Japanese Patent-Inserted Official Gazette No. 2947350 a technique for forming a projecting portion on the substrate as domain regulating means. FIGS. 2A to 2C are views illustrating the principle that is relevant thereto. As illustrated in FIG. 2A, in a state where no voltage is applied, the liquid crystal molecule is oriented in a direction vertical to the surface of the substrate. Applying an intermediate voltage results in that, as illustrated in FIG. 2B, at the electrode slit portion (electrode edge portion), an electric field that is inclined with respect to the surface of the substrate occurs. Also, the liquid crystal molecule at the projecting portion 20 is slightly inclined from that in a state where no voltage is applied. Due to the inclined surface of the projecting portion as well as the electric field that occurs slantwise, the direction in which the liquid crystal molecule is inclined is determined. Thereby, at the position just central between the projecting portion 20 and the electrode slit, the direction in which the liquid crystal molecule is oriented is divided into a plurality of directions. At this time, a light that transmits, for example, from just below to just above is somewhat affected by birefringence and that transmission is suppressed because the liquid crystal molecule is somewhat inclined. As a result of this, a half tone of gray display is obtained. In a region where the liquid crystal molecule is inclined leftward, a light that transmits from right lower to left upper has the difficulty of transmitting, and, in a region where the liquid crystal molecule is inclined rightward, is very easy to transmit. Therefore, when averaged, a half tone of gray display is obtained. According to the same principle, a light that transmits from left lower to right upper, also, enables a display of gray. Namely, a uniform level of display is obtained in omni-direction. Further, when a prescribed voltage is applied, the liquid crystal molecule becomes laid horizontal, whereby a display of white is obtained. Accordingly, in all states of display that include a state's of black being displayed, a state's of half tone being displayed, and a state's of white being displayed, excellent display that has less dependency on the viewing angle is obtained. The official gazette referred to above describes like that.

However, the above-described method necessitates forming the structural member of “projecting portion” on the liquid crystal substrate and, therefore, has various points in problem such as making the manufacturing process complex, increasing the cost, and decreasing the yield.

### DISCLOSURE OF INVENTION

The present invention has been made in view of the above-described points in problem and has a main object to provide an orientation film that enables the liquid-crystalline molecule to be appropriately oriented without forming a structural member of “projecting portion” such as that described above and, in addition, without performing rubbing.

To attain the above object, the present invention provides an orientation film which comprises a pattern, on its surface of a side where a liquid crystal layer is contacted, that includes a water-repellent region and a hydrophilic region that is a region where the angle of contact with water is smaller than that in the water-repellent region. By forming the hydrophilic region, within the water-repellent region, into a pattern configuration in the above-described way, for example in a liquid crystal display device in vertical orientation mode, it becomes possible, by utilizing the nature that the liquid crystal molecule that is vertically oriented in the water-repellent region is inclined within the hydrophilic region, to perform orientation division, within a relevant pixel, of the liquid crystal molecule that has been vertically oriented. Accordingly, by using that orientation film, it is possible to easily perform the orientation division within the pixel and to make the liquid crystal display device the one having less dependency on the viewing angle through the same action as that which occurs when having formed the projecting portion that was stated before.

In the present invention, preferably, the angle of contact with water in the water-repellent region is greater by an angle falling within a range of from 10° to 120° than that in the hydrophilic region. This is because, by making the difference in wettability between the water-repellent region and the hydrophilic region the one that corresponds to the range, it is possible to more effectively perform orientation within the pixel of the liquid crystal molecule.

Also, in the present invention, it is preferable that the angle of contact with water in the water-repellent region falls within a range of from 40° to 120°. This is because, in a case of using the orientation film in, for example, the liquid crystal display device in vertical orientation mode, in order to vertically orient the liquid crystal molecule within the water-repellent region, it is preferable that the orientation film has a water repellency that is to an extent described above.

Also, in the present invention, the orientation film comprises a compound that has polyimide, polyamide, or organopolysiloxane as the principal chain and has as the side chain linear alkyl group, or fluorine-containing alkyl group, the number of carbons of which is from 4 to 22 inclusive; and the density of the side chains in the water-repellent region is lower than that of the side chains in the hydrophilic region.

As described above, the present invention is based on the utilization of the nature that the liquid crystal molecule in the water-repellent region is vertically oriented and that in the hydrophilic molecule is inclined. However, if, for example, using the orientation film in the liquid crystal display device in vertical orientation mode, further using the orientation film having formed on its surface side chains for vertically orienting the liquid crystal molecule is preferable for enhancing the orientation property of the liquid crystal molecule. From this point of view, the orientation film that comprises the compound described above is preferable. Further, from the point of view that in the hydrophilic region the liquid crystal molecule preferably is inclined in that region, it is preferable that the density of the side chains be lower in the hydrophilic region than in the water-repellent region.

In the water-repellent region, preferably, the weight of the side chains is 5% by weight or more based upon the total weight of the relevant material (orientation film material). This is because, if having the side chains that are to that extent, the orientation film comes to have an orientation property that is sufficient as the orientation film.

In the present invention, preferably, the organopolysiloxane is polysiloxane that contains therein a fluoroalkyl group and is the one that is a hydrolytic condensate or co-hydrolytic condensate of one, or two or more, kinds of silicon compounds each of which is expressed by YₙSiX₍₄₋ₙ₎ (where Y represents an alkyl group, fluoroalkyl group, vinyl group, amino group, phenyl group, or epoxy group; X represents an alkoxyl group or halogen; and n represents an integer of from 0 to 3 inclusive.). The reason for this is as follows. By, using the organopolysiloxane that is like that, performing treatment with the use of a photocatalyst-containing layer substrate that will later be described, it is possible to relatively easily create the hydrophilic region in the water-repellent region and to make greater the difference in wettability between the water-repellent region and the hydrophilic region. Therefore, this material is suitable for causing orientation within the pixel of the liquid crystal molecule.

Also, in the present invention, preferably, the polyimide is the one that is prepared by causing reaction and polymerization of at least a tetracarboxylic acid component and a diamine component containing a linear alkyl group and thereby making this material a polyimide precursor containing therein a linear alkyl group and imidizing the precursor. The reason for this is as follows. The polyimide is the one that has hitherto been used as the orientation film and, when forming the orientation film using the material, the possibility is very low that the inconvenience will arise.

Also, the present invention provides a method of manufacturing an orientation film, which comprises an orientation film-forming process for forming an orientation film on a substrate, and a pattern-forming process for forming with respect to the surface of the orientation film a pattern including a water-repellent region and a hydrophilic region that is a region where the angle of contact with water is smaller than that in the water-repellent region.

In the present invention, since, only by forming the wettability pattern including the water-repellent region and the hydrophilic region on the orientation film in the above-described way, it is possible to orient within the pixel, there exists a merit of enabling more easily manufacturing than by using a method of, for example, forming a structural member such as a projecting portion.

Also, in the present invention, preferably, the orientation film formed on the substrate is a change-in-wettability layer the wettability on whose surface changes due to the action of photocatalyst; and the pattern-forming process comprises:
a photocatalyst-containing layer side substrate-preparing process for preparing a photocatalyst-containing layer side substrate that has a photocatalyst-containing layer containing therein photocatalyst and a base material member; and
a photocatalyst-treating process for, after disposing the photocatalyst-containing layer and the change-in-wettability layer in the way that the gap therebetween becomes 200 μm or less, radiating light energy from a prescribed direction onto the resulting mass to thereby form a pattern, including a hydrophilic region and a water-repellent region, with respect to the surface of the change-in-wettability layer.

The reason for this is as follows. Namely, only by using the change-in-wettability and disposing the photocatalyst-containing layer in the way that a prescribed gap exists between the two layers and thereafter radiating light energy in the above-described way, it is possible to form the change-in-wettability layer, i.e. a pattern on the orientation film where the wettability in each region is different. Therefore, the wettability pattern can be very easily formed on the orientation film and it is possible to easily form the orientation film wherein the orientation within the pixel is excellent.

In the present invention, preferably, the photocatalyst-containing layer side substrate comprises a base material member and a photocatalyst-containing layer that has formed, on the substrate, into a pattern configuration. This is because, by forming the photocatalyst-containing layer into a pattern configuration like that, it becomes possible to form on the change-in-wettability layer a pattern including the water-repellent region and the hydrophilic region, which are different from each other in terms of the wettability, without using any photo-mask. In addition, since only the surface of contact with the photocatalyst-containing layer changes into the hydrophilic region, the energy that is to be radiated is not particularly limited to parallel rays of energy and, also, the radiation direction of the energy is not particularly limited. Therefore, there exists a merit that the kinds of energy sources and the degree of freedom in which they are disposed greatly increase.

Also, the photocatalyst-containing layer side substrate that is prepared in the photocatalyst-containing layer side substrate-preparing process comprises a base material member, a photocatalyst-containing layer formed on the substrate, and a photocatalyst-containing layer side light-shielding portion formed into a pattern configuration; and the radiation of the energy in the pattern-forming process may be performed from the photocatalyst-containing layer side substrate.

By the photocatalyst-containing layer side substrate's having the photocatalyst-containing layer side light-shielding portion in that way, there is no necessity of using a photo-mask, etc. when performing exposure, which eliminates the necessity of performing positional alignment, etc. with the photo-mask. Resultantly, it becomes possible to simplify the relevant process.

Further, in the photocatalyst-containing layer side substrate, the photocatalyst-containing layer side light-shielding portion may be formed into a pattern configuration on the base material member; and, further, on the light-shielding portion, there may be formed the photocatalyst-containing layer. Also, in the photocatalyst-containing layer side substrate, the photocatalyst-containing layer may be formed on the base material member and, on this photocatalyst-containing layer, the photocatalyst-containing layer sidelight-shielding portion may be formed into a pattern configuration.

It can be said preferable that the photocatalyst-containing layer side light-shielding portion is disposed at a position that is near to the position of contact with the change-in-wettability layer in terms of the accuracy of the wettability pattern obtained. Therefore, it is preferable to dispose the photocatalyst-containing layer side light-shielding portion at the position. Also, in a case of forming the photocatalyst-containing layer side light-shielding portion on the photocatalyst-containing layer, there exists a merit that the photocatalyst-containing layer side light-shielding portion can be used as a spacer when disposing the photocatalyst-containing layer and the change-in-wettability layer in the wettability pattern-forming process with a gap intervening in between.

In the present invention, preferably, the photocatalyst-containing layer is a layer that consists of photocatalyst. The reason for this is as follows. If the photocatalyst-containing layer is a layer that consists of only photocatalyst, it is possible to enhance the efficiency of changing the wettability of the change-in-wettability layer. It is therefore possible to form a wettability pattern on the surface of the orientation film with a high efficiency.

Also, in the present invention, preferably, the photocatalyst-containing layer is a layer that is prepared by forming photocatalyst onto the base material member, as a film, by a vacuum film-making technique. The reason for this is as follows. By forming the photocatalyst-containing layer by the vacuum filmmaking technique in the above-described way, it becomes possible to make the layer the one the surface of which has less unevenness and the thickness of which is uniform and which is homogeneous and, further, it becomes possible to uniformly and highly efficiently form the wettability pattern with respect to the surface of the change-in-wettability layer.

Also, the photocatalyst-containing layer may be a layer that has photocatalyst and a binder. The reason for this is as follows. By using a binder like that, it becomes possible to relatively easily form the photocatalyst-containing layer and, as a result, to manufacture a pattern formation at a low cost.

Further, the present invention provides an orientation film-equipped substrate which comprises a substrate, and an orientation film that is formed on the substrate and that has on its surface on a side where a liquid crystal layer is contacted therewith a pattern including a water-repellent region and a hydrophilic region that is a region where the angle of contact with water is smaller than that in the water-repellent region. By the substrate's having the orientation film having formed in its water-repellent region the hydrophilic region in the configuration of a pattern in the above-described way, in a case of using the substrate in the liquid crystal display device in, for example, vertical orientation mode, it becomes possible, by utilizing the nature that the liquid crystal molecule that is vertically oriented in the water-repellent region gets inclined in the hydrophilic region, to cause orientation/division within a relevant pixel of the liquid crystal molecule that has vertically been oriented.

Also, in the present invention, the orientation film-equipped substrate may be the one wherein the liquid crystal layer is disposed on a side where the surface of the orientation film is located, or may be the one that has formed on its surface a colored layer; and on the surface of the colored layer there is formed a transparent electrode layer; and on the transparent electrode layer there is formed the orientation film.

Further, also, the present invention provides a liquid crystal display device which comprises:
a color filter side substrate that has a first substrate, a colored layer that is formed on the first substrate, a transparent electrode layer formed on the colored layer, and an orientation film that is formed on the transparent electrode layer and that has on its surface on a side where a liquid crystal layer is contacted therewith a pattern including a water-repellent region and a hydrophilic region that is a region where the angle of contact with water is smaller than that in the water-repellent region, and
an opposing substrate that has a second substrate, a transparent electrode layer formed on the second substrate, and an orientation film that is formed on the surface of the transparent electrode layer and that has on its surface on a side where a liquid crystal layer is contacted therewith a pattern including a water-repellent region and a hydrophilic region that is a region where the angle of contact with water is smaller than that in the water-repellent region,
whereby the orientation film of the color filter side substrate and the orientation film of the opposing substrate are disposed in the way they oppose each other; and
liquid crystal is sealed into between the two orientation films.

The liquid crystal display device is the one that has an orientation film having formed within its water-repellent region in the form of a pattern the hydrophilic region. Therefore, for example, in the liquid crystal display device in vertical orientation mode, by utilizing the nature that the liquid crystal molecule that is vertically oriented in the water-repellent region gets inclined in the hydrophilic region, it is possible to cause orientation/division within the pixel of the liquid crystal molecule that has been vertically oriented.

### BRIEF DESCRIPTION OF DRAWINGS

FIG. 1 is an explanatory view illustrating a liquid crystal display device in vertical orientation mode;

FIG. 2 is an explanatory view illustrating a conventional example of a liquid crystal display device in vertical orientation mode within a pixel of that the orientation-direction differentiation (division) is made;

FIG. 3 is a plan view illustrating a hydrophilic pattern that is used in the orientation film used in an MVA mode;

FIG. 4 is a plan view illustrating an example wherein a liquid-crystalline molecule is disposed on the hydrophilic pattern illustrated in FIG. 3;

FIG. 5 is a schematic sectional view illustrating a state where the example illustrated in FIG. 4 is viewed from a section thereof;

FIG. 6 is a plan view illustrating a hydrophilic pattern that is used in the orientation film used in an IPS mode;

FIG. 7 is a plan view illustrating an example wherein a liquid-crystalline molecule is disposed on the hydrophilic pattern illustrated in FIG. 6;

FIG. 8 is a schematic sectional view illustrating a state where the example illustrated in FIG. 7 is viewed from a section thereof;

FIG. 9 is a plan view illustrating a hydrophilic pattern that is used in the orientation film used in a TN mode;

FIG. 10 is a plan view illustrating an example wherein a liquid-crystalline molecule is disposed on the hydrophilic pattern illustrated in FIG. 9;

FIG. 11 is a schematic sectional view illustrating a state where the example illustrated in FIG. 10 is viewed from a section thereof;

FIG. 12 is a schematic sectional view illustrating an example of a photocatalyst-containing layer side substrate that is used in the present invention;

FIG. 13 is a schematic sectional view illustrating another example of the photocatalyst-containing layer side substrate that is used in the present invention;

FIG. 14 is a schematic sectional view illustrating still another example of the photocatalyst-containing layer side substrate that is used in the present invention;

FIG. 15 is a schematic sectional view illustrating a further example of the photocatalyst-containing layer side substrate that is used in the present invention;

FIG. 16 is a schematic sectional view illustrating an example of an orientation film-equipped substrate according to the present invention;

FIG. 17 is a schematic sectional view illustrating another example of the orientation film-equipped substrate according to the present invention;

FIG. 18 is a schematic sectional view illustrating still another example of an orientation film-equipped substrate according to the present invention;

FIG. 19 is a schematic sectional view illustrating an example of a liquid crystal display device according to the present invention; and

FIG. 20 is a schematic sectional view illustrating a vertical orientation mode of liquid crystal display device that includes an orientation film according to an embodiment of the present invention.

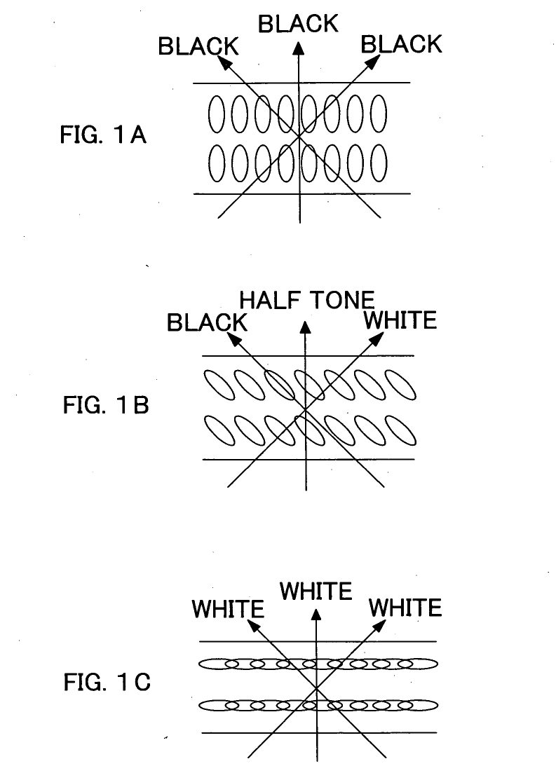

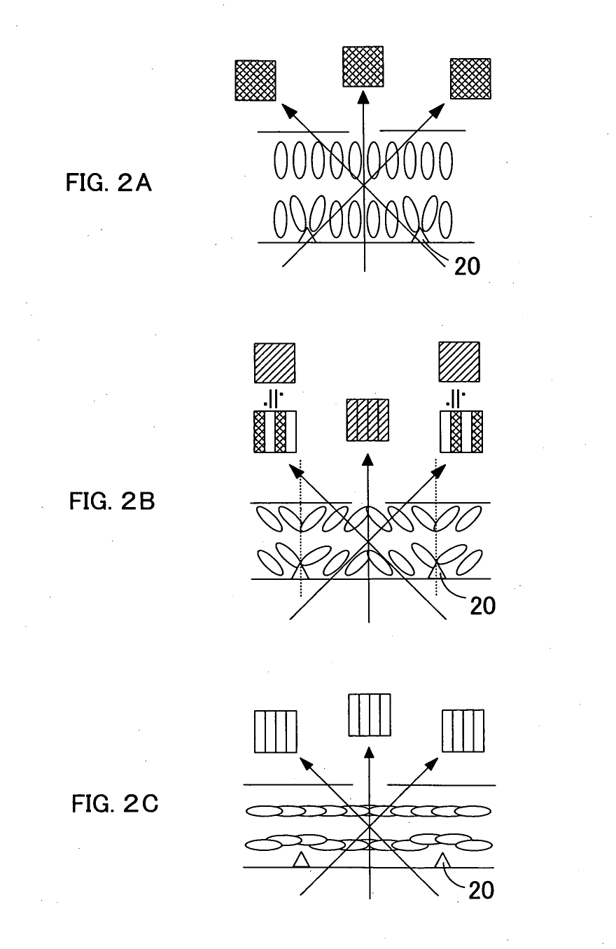

### BEST MODE FOR CARRYING OUT THE INVENTION

Hereinafter, the present invention will be concretely explained. The present invention includes an orientation film, a method of manufacturing the orientation film, an orientation film-equipped substrate, and a liquid crystal display device. Hereinafter, each of these will be explained, individually, under its relevant item.

A. Orientation Film

An orientation film according to the present invention is characterized by having on the surface thereof that is located on a side where a liquid crystal layer is contacted therewith a pattern that includes a water-repellent region and a hydrophilic region where the angle of contact with water is smaller than that in the water-repellent region.

In the present invention, by that surface's of the orientation film being defined as being the water-repellent region and by the pattern's of hydrophilic region being formed within the water-repellent region in the above-described way, it becomes possible to perform orientation in direction of the liquid crystal molecule within a relevant pixel. The reason for this is as follows.

Namely, in, for example, a liquid crystal display device in vertical orientation mode (hereinafter also referred to as “MVA mode” as the occasion demands), on the surface having water repellency, of the orientation film that is located within a region forming the relevant pixel, a prescribed pattern of hydrophilic region is formed. Regarding the liquid-crystalline molecule, although in terms of its nature it is vertically oriented within the water-repellent region, it is slightly obliquely oriented within the hydrophilic region. Accordingly, by adjusting the degree of wettability, configuration, etc. of this hydrophilic region, it becomes possible to control the orientation direction of the liquid-crystalline molecule in the same pixel so that it may be differentiated, or divided, into two, or four, different directions. Accordingly, by using the orientation film formed like that, it is possible to provide a liquid crystal display device that has less dependency on the viewing angle.

Also, in a case where the liquid crystal molecule is arrayed in parallel with the substrate as in an IPS mode, the TN mode, etc., since the liquid crystal molecule is oriented along the pattern of hydrophilic region, forming a pattern of hydrophilic region shaped like a stripe enables orienting the liquid crystal molecule. In the present invention, there is the merit that, by using the technique, it is possible to form an orientation layer without executing a rubbing process that has hitherto been carried out.

(Water-Repellent Region and Hydrophilic Region)

The orientation film according to the present invention is characterized by having formed on the surface thereof that is on a side where the liquid crystal layer is contacted therewith as described above, a pattern including the water-repellent region and the hydrophilic region. This hydrophilic region is not particularly limited only if it is a region where the angle of contact with water is smaller than that in the water-repellent region. The wettability within the hydrophilic region may be uniform or non-uniform.

Also, the difference in wettability between this region and the water-repellent region is not limited in particular. However, from the standpoint of the easiness with which the orientation direction is controlled, etc., it is preferable that the difference between the angle of contact with water in the water-repellent region and that in the hydrophilic region falls within a range of from 10° to 120°, especially a range of from 60° to 120°.

For the material using which the hydrophilic region and the water-repellent region are formed, ordinarily, the same material is used, and, preferably, by performing surface treatment of the surface thereof that utilizes a photocatalyst-containing layer, etc. as later described, the difference in terms of the wettability is caused to occur. However, the present invention is not particularly limited thereto, and a different material may be used between for forming the hydrophilic region and for forming the water-repellent region.

The pattern configuration of the hydrophilic region within the region where the relevant pixel is formed can be various depending on the type of a liquid crystal display device having used therein an orientation film.

For instance, in the liquid crystal display device in MVA mode, any pattern is available only if it is a type that, within the pixel thereof, is able to divide and control the orientation direction of the liquid crystal molecule. The pattern is different depending on the difference in wettability between the hydrophilic region and the water-repellent region, the kind of the liquid-crystalline molecule, etc. Namely, it is appropriately determined according to the respective conditions that are relevant thereto.

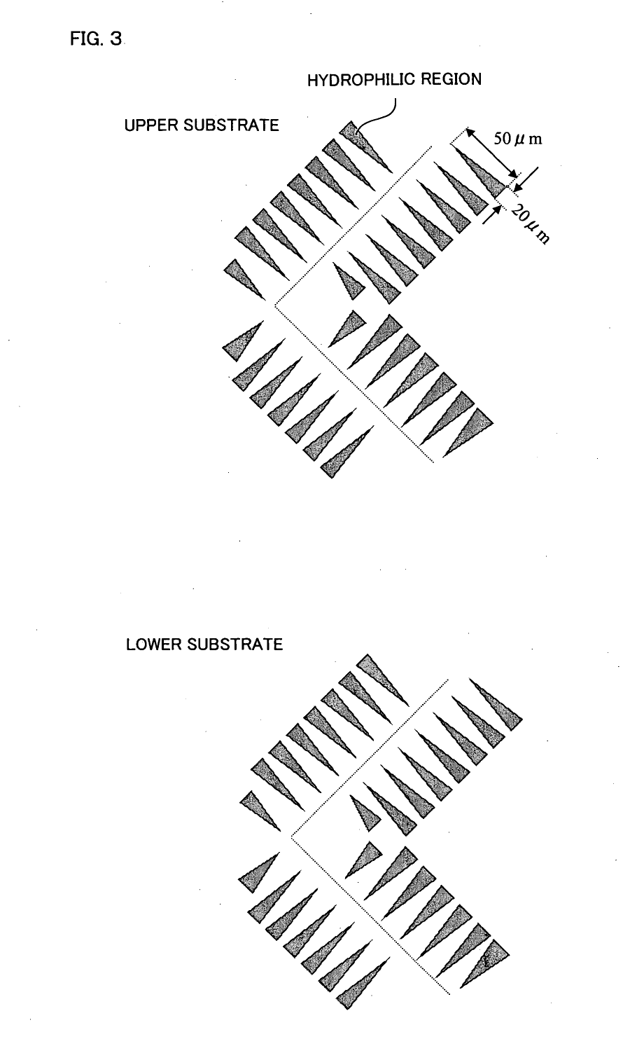

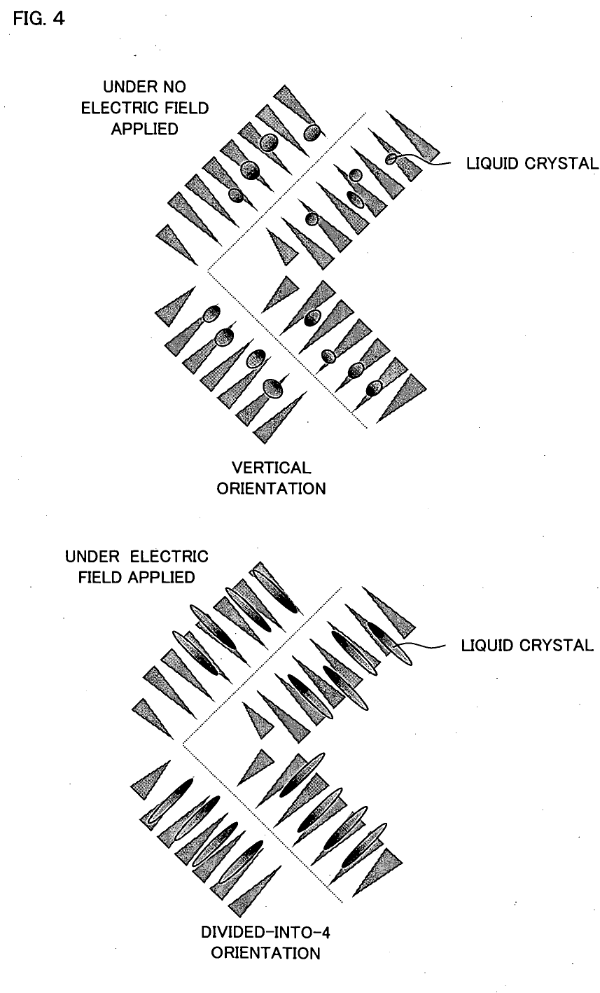

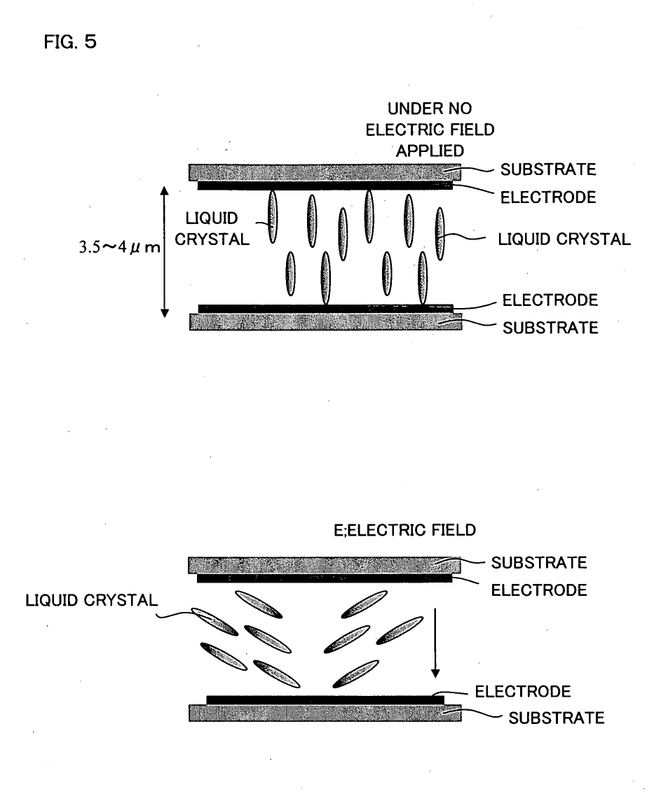

Concretely, a pattern where, as illustrated in FIG. 3, the hydrophilic region is arrayed in the form of a wedge can be taken up as an example. If the pattern is like that, the liquid crystal molecule that is vertically disposed in a state of no electric field's being applied becomes oriented along the wedge type pattern as a result of an electric field's being applied, as illustrated in FIG. 4. Therefore, it becomes possible, within the same pixel, to control the orientation direction of the liquid-crystalline molecule so that the direction may become four different directions. Thereby, the liquid crystal display device can be made the one having less dependency on the viewing angle. The pattern of hydrophilic region, preferably, is formed, as a pattern, on either substrate of both the color filer side substrate and the opposing side substrate. Incidentally, FIG. 5 illustrates a state where the liquid crystal molecule is viewed from a section thereof.

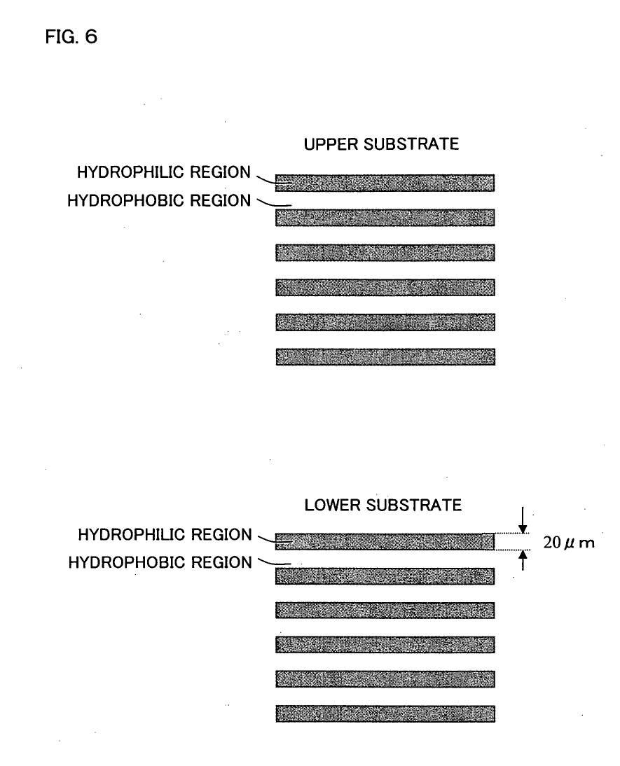

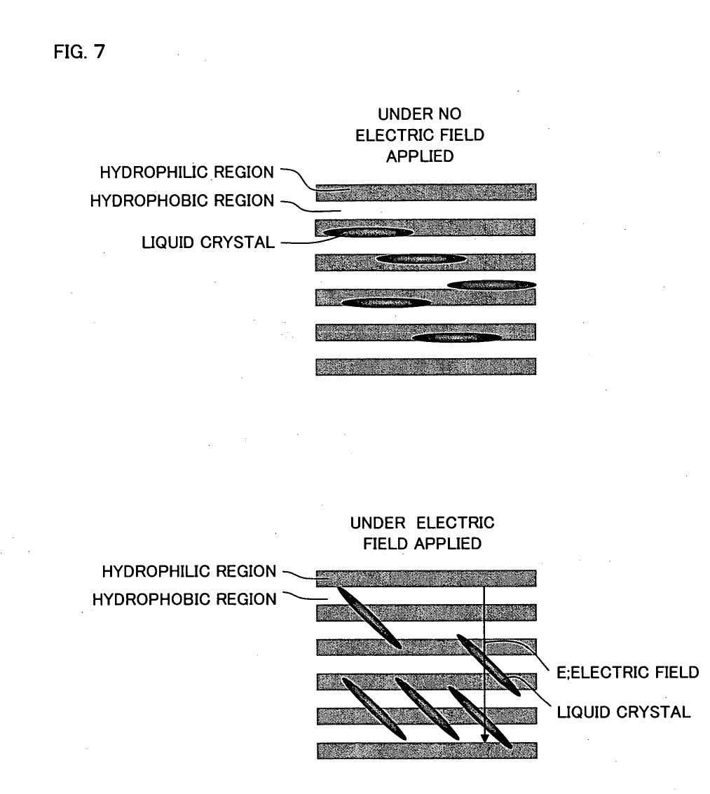

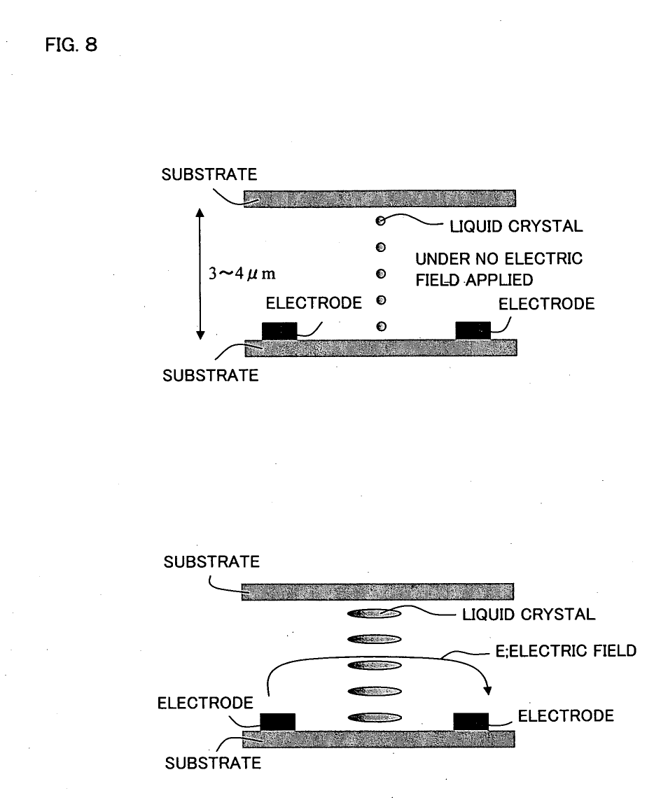

Also, in the liquid crystal display device in IPS mode, as illustrated in FIG. 6, the hydrophilic region is patterned like a stripe. In this case, for example, on either substrate of an upper substrate that is the color filter side substrate and a lower substrate that is the opposing substrate, the pattern is formed in parallel with another one that is adjacent thereto. By the stripe pattern's of hydrophilic region being formed in parallel on either substrate of the upper substrate and lower substrate in that way, as illustrated in FIG. 7, when no electric field is being applied, the liquid crystal molecule is brought to a state of its being oriented in parallel with the hydrophilic region. Also, when an electric field is applied, the liquid crystal region becomes oriented in a direction that intersects the stripe pattern of hydrophilic region. Incidentally, FIG. 8 illustrates a state that appears when the liquid crystal molecule is viewed from a section.

By forming the hydrophilic region into a configuration of stripe in the above-described way, it becomes possible to orient the liquid-crystalline molecule without executing relevant rubbing process with respect to the orientation film.

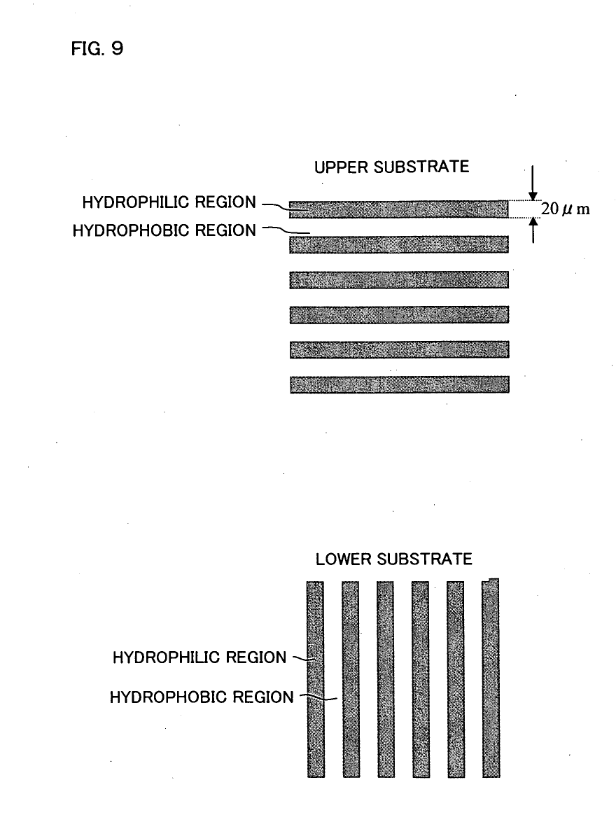

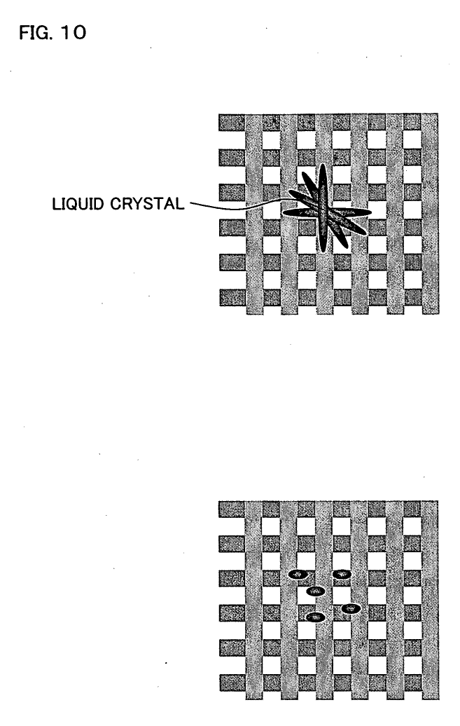

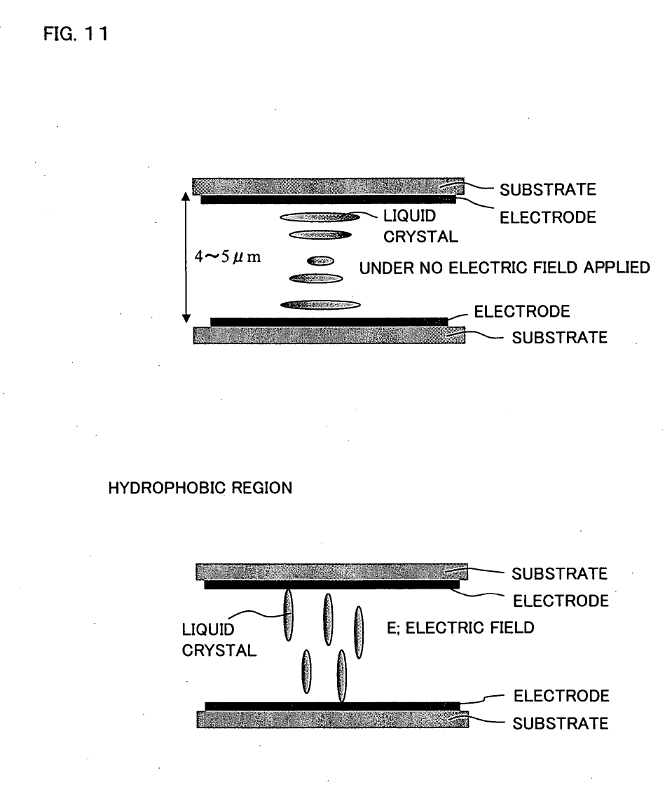

Further, in the liquid crystal display device in TN mode, although, as illustrated in FIG. 9, the hydrophilic region is patterned in the form of a stripe, in the case of the TN mode, the stripe is formed, for example, in the way that the stripe on an upper substrate that is the color filter side substrate and that on a lower substrate that is the opposing substrate intersect each other at a right angle. By the stripe pattern's being formed in the way that the stripe pattern of hydrophilic region on the upper substrate and that on the lower substrate intersect each other at a right angle in the above-described way, the liquid crystal molecule becomes oriented, when no electric field is being applied, into a state of its being twisted 90 degrees from the lower substrate toward the upper substrate, as illustrated in FIG. 10. Also, when an electric field is applied, the liquid crystal molecule is oriented vertically, or perpendicularly, to the substrate. This state is illustrated in FIG. 11 that illustrates a state that appears when the liquid crystal molecule is viewed from a section.

In this case as well, it is possible to use the orientation film as the one able to orient the liquid crystal molecule, without performing rubbing of the orientation film.

Also, the area ratio between the hydrophilic region and the water-repellent region within the region where the pixel is formed, also, greatly differs according to the type, the conditions, etc. the liquid crystal display device used, as in the case of the above-described configuration of the pattern of hydrophilic region. However, from the standpoint that in a case where the hydrophilic region is excessively large, the control ordinarily becomes difficult, etc., under the assumption that the region where the pixel is formed be 100%, the hydrophilic region is formed within a range of from 0.1% to 90%, especially a range of from 0.1% to 50%.

On the other hand, the water-repellent region is ordinarily the one, such as that described above, where surface treatment that uses a photocatalyst-containing layer, etc. is not performed. However, the present invention is not limited thereto. For instance, the pattern of water-repellent region may be the one that has been obtained by performing surface treatment with respect to the original water-repellent region.

This water-repellent region is not particularly limited only if it is the region where the angle of contact with water is greater than that in the hydrophilic region. However, in order to vertically orient the liquid crystal molecule, it is preferable that the water-repellent region has a prescribed level of water repellency. From that viewpoint, in the present invention, the angle of contact with water in the water-repellent region, preferably, is set to fall within a range of from 40° to 120°, especially a range of from 70° to 120°.

Incidentally, the “angle of contact with water” in the present invention is an angular value that is obtained by measuring the angle of contact with water (in 30 sec. after dropping liquid droplets from the micro-syringe) by using an angle of contact measuring instrument (CA-Z type made by Kyowa Interface Science Inc.).

(Material for Orientation Film)

The orientation film according to the present invention does not have a material therefor not particularly limited if it has the above-described water-repellent region and hydrophilic property. However, a high-molecular material having a prescribed side chain is suitably used for the following reasons.

First, as later described, in the present invention, it is preferable to form a pattern of hydrophilic region by performing surface treatment with respect to the surface of the water-repellent region by using a photocatalyst-containing layer. However, when, in the surface treatment using a photocatalyst-containing layer, a relevant material has, for example, an alkyl group or fluorine-containing alkyl group as the side chain, the difference in wettability between the both regions is easier to appear when the surface treatment has been performed. Therefore, the relevant material is preferable in that respect.

Also, as another reason for that, the following can be said. Namely, although in the water-repellent region according to the present invention, it is preferable that the liquid crystal molecule be vertically oriented, in a case where the relevant material has in addition to its orientation film's having water repellency a prescribed number of chains and rubbing processing is performed with respect thereto, the liquid crystal molecule becomes able to be more effectively oriented.

Although the side chain is not particularly limited, normal alkyl group or fluorine-containing alkyl group the number of carbons of which falls within a range of from 40 to 22, preferably from 50 to 10 can be taken up as the example.

Also, in the present invention, it is preferable that, in the water-repellent region, the side chain be the one wherein the weight thereof is 5% by weight or more based upon the total weight. The reason for this is that, if the density of the side chain is to that extent, the water-repellent region can sufficiently exhibit the ability to orient the liquid-crystalline molecule.

On the other hand, although the principal chain that has the above-described side chain is not particularly limited, it preferably is polyimide-, polyamide-, or polysiloxane-based principal chain material.

Hereinafter, an explanation will be given of those materials that are preferable for use as the orientation film under separate items of polyimide-based, polyamide-base, and polysiloxane-based, material.

a. Polyimide-Based

Polyimide resin that is used as the material for the orientation film according to the present invention, preferably, is the one the polyimide of which is the one that is prepared by causing reaction and polymerization of at least a tetracarboxylic acid component and a diamine component containing therein a linear alkyl group and making the resulting material a polyimide precursor containing therein a linear alkyl group and imidizing the precursor.

In the present invention, as that polyimide, there can be used polyimide that is disclosed in, for example, Japanese Patent Application Laid-Open No. 6-3678. Namely, the polyimide containing therein a linear alkyl group is polyimide that is prepared by causing reaction and polymerization between a tetracarboxylic acid component and a diamine component not containing therein a linear alkyl group and/or a diamine component containing therein a linear alkyl group and/or a monoamine containing therein a linear alkyl group and/or a dicarboxlylic acid component containing therein a linear alkyl group, and thereby making the resulting material a polyimide precursor containing therein a linear alkyl group, and imidizing the precursor.

More specifically, a material that is obtained by mixing a diimide compound containing therein a linear alkyl group with respect to polyimide not containing therein a linear alkyl group may be used, and, asthepolyimide side chain, polyimide containing therein a linear alkyl group. A material that is obtained by causing reaction of a linear alkyl group with respect to the molecular chain terminal of polyimide not containing therein a linear alkyl group may be used. However, in order to obtain stable vertical orientation that is intended to be achieved by the present invention, the material must be the one the carbons number of whole linear alkyl group is 12 or more and the content of that, when calculated in terms of the weight of the alkyl group, is 5% or more based upon the total weight of polyimide.

The tetracarboxylic acid component that is used to obtain polyimide used in the present invention is not particularly limited. As the concrete examples, it includes aromatic carboxylic acids, such as pyromellitic acid, 2,3,6,7-naphthalene tetracarboxylic acid, 1,2,5,6-naphthalene tetracarboxylic acid, 1,4,5,8-naphthalene tetracarboxylic acid, 2,3,6,7-anthracene tetracarboxylic acid, 1,2,5,6-anthracene tetracarboxylic acid, 3,3′,4,4′-biphenyl tetracarboxylic acid, 2,3,3′,4-biphenyl tetracarboxylic acid, bis(3,4-dicarboxylphenyl)ether, 3,3′,4,4′-benzophenone tetracarboxylic acid, bis(3,4-dicarboxyphenyl)sulfone, bis(3,4-dicarboxyphenyl)methane, 2,2-bis(3,4-dicarboxyphenyl)propane, 1,1,1,3,3,3-hexafluoro-2,2-bis(3,4-dicarboxyphenyl)propane, bis(3,4-dicarboxyphenyl)dimethyl silane, bis(3,4-dicarboxyphenyl)diphenyl silane, 2,3,4,5-pyridine tetracarboxylic acid, or 2,6-bis(3,4-dicarboxyphenyl)pyridine, dianhydrides thereof, and dicarboxylic acid diacid halides thereof, cycloaliphatic tetracarboxylic acids, such as 1,2,3,4-cyclobutane tetracarboxylic acid, 1,2,3,4-cyclopentane tetracarboxylic acid, 1,2,4,5-cyclohexane tetracarboxylic acid, 2,3,5-tricarboxy cyclopentyl acetic acid, 3,4-dicarboxy-1,2,3,4-tetrahydro-1-naphthalenesuccinic acid, dianhydrides thereof, and dicarboxylic acid diacid halides thereof, and aliphatic tetracarboxylic acids, such as 1,2,3,4-butane tetracarboxylic acid, dianhydrides thereof, and dicarboxylic acid diacid halides thereof.

Especially, from the viewpoint of the transparency of the coating film, cycloaliphatic tetracarboxylic acids, dianhydrides thereof, and dicarboxylic acid diacid halides thereof are preferable. Further, 1,2,3,4-cyclobutane tetracarboxylic acid dianhydrides are preferable. Also, tetracarboxylic acid thereof and one, or two or more, kinds of derivatives thereof can also be used in a form where they are mixed together.

The diamine component that does not contain a linear alkyl group, which is used to obtain polyimide used in the present invention, is a diamine that is generally used to synthesize polyimide, and that is not particularly limited.

The diamine includes, for example, aromatic diamines, such as p-phenylene diamine, m-phenylene diamine, 2,5-diaminotoluene, 2,6-diamino toluene, 4,4′-diamino biphenyl, 3,3′-dimethyl-4,4′-diamino biphenyl, 3,3′-dimethoxy-4,4′-diamino biphenyl, diamino diphenyl methane, diamino diphenyl ether, 2,2-diamino diphenyl propane, bis(3,5-diethyl-4-amino phenyl)methane, diamino diphenyl sulfone, diamino benzophenone, diamino naphthalene, 1,4-bis(4-amino phenoxy)benzene, 1,4-bis(4-amino phenyl)benzene, 9,10-bis(4-amino phenyl)anthracene, 1,3-bis(4-amino phenoxy)benzene, 4,4′-bis(4-phenoxy)diphenylsulfone, 2,2-bis[4-(4-amino phenoxy)phenyl]propane, 2,2-bis(4-amino phenyl)hexafluoropropane, or 2,2-bis[4-(4-amino phenoxy)phenyl]hexafluoropropane, cycloaliphatic diamines, such as bis(4-amino cyclohexyl)methane, or bis(4-amino-3-methyl cyclohexyl)methane, aliphatic diamines such as tetramethylene diamine, hexamethylene diamine, etc., and, further, diaminocyloxanes such as that which is expressed by the chemical formula: 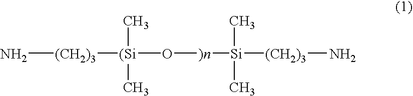
(where the n represents an integer of from 1 to 10 inclusive).

Also, one, or two or more, kinds of these diamines can be used in a form wherein they are mixed together, too. The concrete examples of the diamine components each of which contains therein a linear alkyl group that is used to obtain polyimide used in the present invention include diamino benzene derivatives such as those expressed by the following chemical formula (2), diamino phenyl derivatives such as those expressed by the following chemical formula (3), diamino turphenyl derivatives such as those expressed by the following chemical formula (4), diamino diphenyl ether derivatives such as those expressed by the following chemical formula (5), diphenyl methane derivatives such as those expressed by the following chemical formula (6), and bis(amino phenoxy)phenyl derivatives such as those expressed by the following chemical formula (7). The R in each formula is a linear alkyl group, alkyloxy group, alkyloxymethylene group, etc. the carbons number of which is 12 or more.

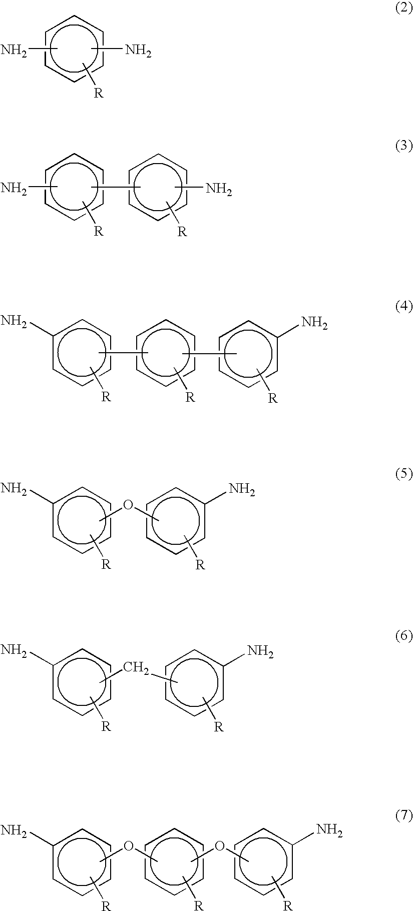

Also, one, or two or more, kinds of these alkyl diamines can also be used in a form wherein they are mixed together. The concrete examples of the monoamine that contains therein a linear alkyl group and that is used to obtain polyimide used in the present invention include aliphatic amines such as those expressed by the following chemical formula (8), cycloaliphatic diamines such as those expressed by the following chemical formula (9), and aromatic amines such as those expressed by the following chemical formula (10). The R in each formula is a linear alkyl group, alkyloxy group, alkyloxymethylene group, etc. the carbons number of which is 12 or more.

Also, one, or two or more, kinds of these alkyl diamines can also be used in a form wherein they are mixed together.
NH₂—R (8)

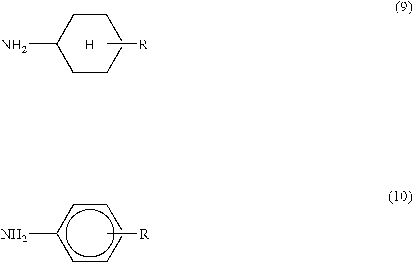

The concrete examples of the dicarboxylic acid component that contains therein a linear alkyl group and that is used to obtain polyimide used in the present invention include aliphatic dicarboxylic acids such as those expressed by the following chemical formula (11), acid anhydrides thereof, and acid halides thereof, cycloaliphatic dicarboxylic acids such as those expressed by the following chemical formula (12), acid anhydrides thereof, and acid halides thereof, and aromatic dicarboxylic acids such as those expressed by the following chemical formula (13), acid anhydrides thereof, and acid halides thereof. The R in each formula is a linear alkyl group, alkyloxy group, alkyloxy methylene group, etc. the carbons number of which is 12 or more.

Also, one, or two or more, kinds of these dicarboxylic acid components can also be used in a form wherein they are mixed together.

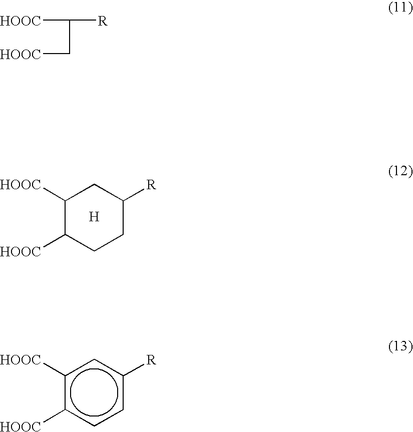

For obtaining the above-described materials, a technique is used of causing reaction and polymerization of the tetracarboxylic acid component and the diamine component to thereby produce a polyimide resin precursor and then performing dehydration, ring closure, and imidizing of that. Generally, as the tetracarboxylic component used at that time, there is used tetracarboxylic acid dianhydride. The ratio of the total number of moles of the tetracarboxylic acid dianhydride to that of the diamine component, preferably, is in a range of from 0.8 to 1.2. As in the case of an ordinary polycondensation reaction, the nearer to 1 the molar ratio is, the higher the polymerization degree of the polymer produced becomes.

If the polymerization degree is excessively low, at the time when using that material as that of the orientation film, the strength of the resulting polyimide film becomes insufficient with the result that the orientation of the liquid crystal molecule becomes unstable. Also, if the polymerization degree is excessively high, in some cases the operating efficiency at the time of forming a polyimide resin film becomes bad. Accordingly, the polymerization degree of the product obtained from the reaction, preferably, is set, when calculated in terms of reduced viscosity of the polyimide precursor solution, to fall within a range of from 0.05 to 3.0 dl/g (having a concentration of 0.5 g/dl in the solution of N-methylpyrrolidone at 30° C.).

Also, as one of the methods for obtaining the polyimide containing therein linear alkyl group which is used in the present invention, there is the one of mixing a diimide compound containing therein a linear alkyl group into the relevant material. For obtaining that diimide compound, there is a method that is to cause reaction of the dicarboxylic acid component and the diamine component containing therein a linear alkyl group in a molar ratio of 2:1 to thereby make the resulting material a diimide compound precursor and then perform dehydration, ring closure, and imidizing of that and/or to cause reaction of the monoamine component containing therein a linear alkyl group and the tetracarboxylic acid dianhydride in a molar ratio of 2:1 to thereby make the resulting material a diimide compound precursor and then perform dehydration, ring closure, and imidizing of that.

Further, as one of the methods for obtaining the polyimide according to the present invention that contains therein a linear alkyl group, there is a method of causing introduction of a linear alkyl group into the terminal of the molecular chain of polyimide. In the case of this method, there is a method that, when causing reaction and polymerization of the tetracarboxylic acid component and the diamine component, is to cause reaction of the dicarboxylic acid component containing therein a linear alkyl group and/or a method that, when causing reaction and polymerization of the tetracarboxylic acid component and the diamine component, is to cause reaction of the monoamine component containing therein a linear alkyl group. When causing reaction of the dicarboxylic acid component containing therein a linear alkyl group, the ratio a/b of the total number (a) of moles of the carboxylic acid residues of the tetracarboxylic acid component and dicarboxylic acid component to the total number (b) of moles of the amine residue of the diamine component, preferably, is 2 or less. Also, when causing reaction of the monoamine component containing therein a linear alkyl group, the ratio a′/b′ of the total number (a′) of moles of the carboxylic acid residue of the tetracarboxylic acid component to the total number (b′) of moles of the amine residues of the diamine component and monoamine component, preferably, is 2 or more.

In a case where the molar ratio a/b is 2 or more, or the molar ratio a′/b′ is 2 or less, when after the relevant material is formed into a polyimide precursor this precursor is subjected to dehydration, ring closure, and imidizing, the reaction of the dicarboxylic acid component or monoamine component becomes insufficient. As a result of this, when the resulting material has been used as the liquid crystal orientation processor, there is the possibility that it will badly affect the property of the liquid crystal. Generally, these tetracarboxylic acid component, diamine component, dicarboxylic acid component, or monoamine component is caused to react in an organic-polar solvent such as a solvent of N-methylpyrrolidone, N,N-dimethyl acetamide, or N,N-dimethyl formamide.

The reaction temperature at which these materials are caused to react to obtain a polyimide precursor can be arbitrarily selected from a range of from −20 to 150°, or preferably from a range of from −5 to 100° C.

Further, by performing heating and dehydration of the polyimide precursor at a temperature of from 100 to 400° C., or performing chemical imidizing of that by using imidizing catalyst, ordinarily used, such as triethyl amine/acetic anhydride.

b. Polyamide

On the other hand, as the polyamide used in the present invention, there can be used, for example, the one that is disclosed in an official gazette of Japanese Patent Application Laid-Open No. 9-230354.

Specifically, there can be taken up as the examples the polyamide the cyclic unit of which can be expressed by the following general formula (14): 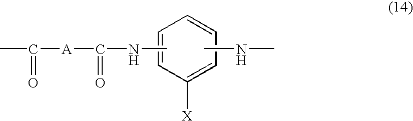
(in the formula (14), A represents a bivalent organic group that constitutes dicarboxylic acid; and X represents the substituent group that is expressed by the following general formula (15):
—Y¹—R¹ (15)
or the following general formula (16): 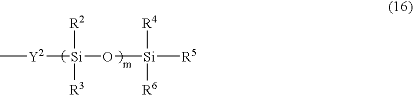
and in the formula (15) or (16) above, Y¹ represents an oxygen atom or a bivalent group that is expressed by —CH₂O—, —C(═O)O— or —OC(═O)—; R¹ represents an alkyl group, or fluorine-containing alkyl group, the carbons number of which is from 8 to 22 inclusive; Y² represents a bivalent organic group that is expressed by —(CH₂)ₙ—, —O(CH₂)ₙ—, —CH₂O(CH₂)ₙ—, —C(═O)O(CH₂)ₙ—, or —OC(═O)(CH₂)ₙ— (n represents an integer of from 2 to 6 inclusive); R² to R⁶ each may be the same or different and each represent an alkyl group that has a carbons number of from 1 to 6 inclusive; and m represents an integer of 1 or more) and the weight average molecular weight of that is 1000 or more, etc.

As the alkyl group that is represented by the R¹ in the general formula (15), there can be taken up as the examples linear alkyl groups such as octyl group, nonyl group, undecyl group, decyl group, dodecyl group, tridecyl group, tetradecyl group, pentadecyl group, hexadecyl group, heptadecyl group, octadecyl group, eicosanyl group, and docosanyl group as well as branching alkyl groups such as 1-ethyl hexyl group, 2-ethyl hexyl group, 3-ethyl hexyl group, 1-methyl heptyl group, 2-methyl heptyl group, 3-methyl heptyl group, 1-methyl octyl group, 2-methyl octyl group, 2-ethyl octyl group, 1-methyl decyl group, 2-methyl decyl group, 3-methyl decyl group, 1-methyl dodecyl group, 1-methyl tetradecyl group, 1-methyl hexadecyl group, 1-methyl octadecyl group, 1-methyl eicosanyl group, and 2-ethyl eicosanyl group.

Also, as the fluorine-containing alkyl group that is represented by the R¹, there can be taken up as the examples the one wherein one or more of the hydrogen atoms of the alkyl group have been substituted by fluorine atoms. However, as the alkyl group which is particularly preferable, there can be taken up as the examples perfluoro octyl group, perfluoro nonyl group, perfluoro undecyl group, perfluoro decyl group, perfluoro dodecyl group, perfluoro tridecyl group, perfluoro tetradecyl group, perfluoro pentadecyl group, perfluoro hexadecyl group, perfluoro heptadecyl group, perfluoro octadecyl group, perfluoro eicosanyl group, perfluoro docosanyl group, 1H,1H-pentadecafluoro octyl group, 1H,1H-heptadecafluoro nonyl group, 1H,1H-nonadecafluoro decyl group, 1H,1H-henicosafluoro undecyl group, 1H,1H-tricosafluoro dodecyl group, 1H,1H-pentacosafluoro tridecyl group, 1H,1H,2H,2H-tridecafluoro octyl group, 1H,1H,2H,2H-heptadecafluoro decyl group, 1H,1H,2H,2H-henicosafluoro dodecyl group and 1H,1H,2H,2H-pentacosafluoro tetradecyl group, 1H,1H,2H,2H-pentacosafluoro tetradecyl group, etc. Incidentally, each of the above-described alkyl group and fluorine-containing alkyl group may be arbitrarily different every cyclic unit.

Also, as the alkyl group that is represented by the R² to R⁶ in the general formula (16), there can be taken up as the examples a linear or branching lower alkyl group such as a methyl group, ethyl group, propyl group, isopropyl group, butyl group, isobutyl group, t-butyl group, pentyl group, or hexyl group. However, from the view point of the easiness with which the relevant materials are synthesized and of causing them to exhibit their properties as the liquid crystal orientation film, among the substituent groups that have been enumerated above, the methyl group is the most preferable.

c. Polysiloxane

When a thought is given from the viewpoint of performing surface treatment with the photocatalyst-containing layer as later described, as the material used for the orientation layer according to the present invention, the material the wettability of which is changed, by exposure, due to the action of the photocatalyst in the photocatalyst-containing layer it contacts with and which has a principal chain unlikely to deteriorate and be decomposed due to the action of the photocatalyst is preferable. From this point of view, organopolysiloxane can be taken up as the preferable material. Among all, in the present invention, preferably, the organopolysiloxane is the one that contains therein a fluoroalkyl group.

As that organopolysiloxane, there can be taken up as the example the one that, through sol/gel reaction or the like, hydrolyzes, and does polycondensation of, chloro-based material or alkoxysilane or the like, thereby exhibiting a high level of strength.

In that case, preferably, that is the organopolysiloxane that is hydrolytic condensation or co-hydrolytic condensation of one, or two or more, kinds of a silicon compound that is expressed by the general formula:
YₙSiX(₄₋ₙ₎
(where Y represents an alkyl group, fluoroalkyl group, vinyl group, amino group, phenyl group or epoxy group; X represents an alkoxyl group, acetyl group, or halogen; and n represents an integer of from 0 to 3 inclusive.). Incidentally, here, the groups that each are represented by the Y preferably each have a carbons number of from 1 to 20 inclusive, and, also, the alkoxy groups that each are represented by the X, preferably, are methoxy group, ethoxy group, propoxy group, and butoxy group.

Also, there can be preferably used the organopolysiloxane that contains therein, especially as the side chain, the fluoroalkyl group that is illustrated below. In more detail, there can be taken up as the examples the hydrolytic condensate and co-hydrolytic condensate of one, or two or more, kinds of the fluoro alkylsilane that is illustrated below.
CF₃(CF₂)₃CH₂CH₂Si(OCH₃)₃;
CF₃(CF₂)₅CH₂CH₂Si(OCH₃)₃;
CF₃(CF₂)₇CH₂CH₂Si(OCH₃)₃;
CF₃(CF₂)₉CH₂CH₂Si(OCH₃)₃;
(CF₃)₂CF(CF₂)₄CH₂CH₂Si(OCH₃)₃;
(CF₃)₂CF(CF₂)₆CH₂CH₂Si(OCH₃)₃;
(CF₃)₂CF(CF₂)₈CH₂CH₂Si(OCH₃)₃;
CF₃(C₆H₄)C₂H₄Si(OCH₃)₃;
CF₃(CF₂)₃(C₆H₄)C₂H₄Si(OCH₃)₃;
CF₃(CF₂)₅(C₆H₄)C₂H₄Si(OCH₃)₃;
CF₃(CF₂)₇(C₆H₄)C₂H₄Si(OCH₃)₃;
CF₃(CF₂)₃CH₂CH₂SiCH₃(OCH₃)₂;
CF₃(CF₂)₅CH₂CH₂SiCH₃(OCH₃)₂;
CF₃(CF₂)₇CH₂CH₂SiCH₃(OCH₃)₂;
CF₃(CF₂)₉CH₂CH₂SiCH₃(OCH₃)₂;
(CF₃)₂CF(CF₂)₄CH₂CH₂SiCH₃(OCH₃)₂;
(CF₃)₂CF(CF₂)₆CH₂CH₂Si₂CH₃(OCH₃)₂;
(CF₃)₂CF(CF₂)₈CH₂CH₂Si₂CH₃(OCH₃)₂;
CF₃(C₆H₄)₃C₂H₄SiCH₃(OCH₃)₂;
CF₃(CF₂)₃(C₆H₄)C₂H₄SiCH₃(OCH₃)₂;
CF₃(CF₂)₅(C₆H₄)C₂H₄SiCH₃(OCH₃)₂;
CF₃(CF₂)₇(C₆H₄)C₂H₄SiCH₃(OCH₃)₂;
CF₃(CF₂)₃CH₂CH₂Si(OCH₂CH₃)₃;
CF₃(CF₂)₅CH₂CH₂Si(OCH₂CH₃)₃;
CF₃(CF₂)₇CH₂CH₂Si(OCH₂CH₃)₃;
CF₃(CF₂)₉CH₂CH₂Si(OCH₂CH₃)₃; and
CF₃(CF₂)₇SO₂N(C₂H₅)C₂H₄CH₂Si(OCH₃)₃

By using as the orientation layer the polysiloxane that contains therein, as the side chain, one of the above-enumerated fluoroalkyl groups, the water repellency in the non-exposed portion of the change-in-wettability layer can be greatly enhanced and, in addition, because of the side chain's being formed, the orientation property can be greatly enhanced.

(Etceteras)

Regarding the thickness of the orientation film according to the present invention, although it is not particularly limited, it preferably falls within a range of from 10 Å to 2000 Å. Also, regarding the position at which the orientation film of the present invention is disposed, the film is disposed at the position at which, in the liquid crystal display device in vertical orientation mode, a relevant orientation film is ordinarily disposed, namely in the way of sandwiching the liquid crystal layer. Also, although, ordinarily, the orientation film according to the present invention is disposed on either one of the color filter side, or an array substrate side, of the liquid crystal layer, it may be disposed on each side.

B. Method of Manufacturing an Orientation Film

Next, a method of manufacturing the orientation film included in the claimed scope of the present invention will be explained. The method of manufacturing the orientation film according to the present invention is characterized by comprising an orientation film-forming process for forming the orientation film on a relevant substrate and a pattern-forming process for forming with respect to the surface of the orientation film a pattern including a water-repellent region and a hydrophilic region that is a region where the angle of contact with water is smaller than that in that water-repellent region.

In the present invention, only by forming the pattern including the water-repellent region and hydrophilic region on the orientation film in the above-described way, it is possible to orient the liquid crystal molecule within the pixel. Accordingly, in a case where the liquid crystal display device is the one in MVA mode, it becomes possible to more easily divide the orientation direction of the liquid crystal molecule within the pixel than do it by the method of, for example, forming a structural member such as the projecting portion.

(Orientation Film Forming Process)

In the orientation film-forming process of the present invention, first, an orientation film-forming process for forming the orientation film on the relevant substrate is executed.

Here, as the substrate used in the present invention, a transparent material can be used regardless of whether it is the one such as glass that has no flexibility or the one such as a resinous film that has flexibility.

Generally, on the substrate, various kinds of functional layers including a transparent electrode layer are formed and, on the resulting structure, there is formed the orientation film.

The method of treatment in that orientation film-forming process is greatly different depending on the material used therein. Accordingly, there is suitably selected the method of forming the orientation film by considering the material that is used, and, then, the orientation film is formed.

(Pattern-Forming Process)

In the present invention, after executing the above-described orientation film-forming process, there is executed the pattern-forming process for forming with respect to the surface of the orientation film the pattern including a water-repellent region and a hydrophilic region that is a region where the angle of contact with water is smaller than that in the water-repellent region.

In the present invention, the method for forming the above-described pattern including the water-repellent region and hydrophilic region is not particularly limited. For instance, as the method, there can be taken up as the example a method of radiating a prescribed active energy grade line such as ultraviolet rays for a long period of time. However, among all, a method that uses a photocatalyst-containing layer is suitably used. The reason for this is that, by using a photocatalyst-containing layer, it is possible to efficiently form the pattern of hydrophilic region with respect to within the water-repellent region in a short period of time.

More specifically, it is preferable to use a method of manufacturing an orientation film, wherein the orientation film formed on the substrate is a change-in-wettability layer the wettability on whose surface changes due to the action of photocatalyst; and the pattern-forming process comprises:
a photocatalyst-containing layer side substrate-preparing process for preparing a photocatalyst-containing layer side substrate that has a photocatalyst-containing layer containing therein photocatalyst and a base material member; and
a photocatalyst-treating process for, after disposing the photocatalyst-containing layer and the change-in-wettability layer in the way that the gap therebetween becomes 200 μm or less, radiating light energy from a prescribed direction onto the resulting mass to thereby form a pattern, including a hydrophilic region and a water-repellent region, with respect to the surface of the change-in-wettability layer.

Hereinafter, an explanation will be given of the method of forming, by using the photocatalyst, a pattern having different regions of wettability, with respect to the surface of the orientation film.

1. Change-In-Wettability Layer

In the present invention, the orientation film formed on the substrate, preferably, is a change-in-wettability layer the wettability of whose surface changes due to the action of the photocatalyst. As the material of that change-in-wettability layer there can be taken up as the examples, generally, a compound that has a side chain comprising an alkyl group, fluorine-containing alkyl group, or the like, which is decomposable by photocatalyst. As that compound, more specifically, there can be taken up as the examples polyimide-based compounds, polyamide-based compounds, and polysiloxane-based compounds which were explained under the preceding item “A. Orientation film”.

2. Photocatalyst-Containing Layer Side Substrate-Preparing Process

The photocatalyst-containing layer side substrate-preparing process according to the present invention is a process for preparing a photocatalyst-containing layer side substrate having a photocatalyst-containing layer containing therein photocatalyst and a base material member.

In that way, the photocatalyst-containing layer side substrate that is manufactured in that process is the one having at least the photocatalyst-containing layer and a base material member and, ordinarily, is the one wherein there is formed on the base material member the photocatalyst-containing layer shaped like a thin film which has been formed by a prescribed method. Also, as that photocatalyst-containing layer side substrate, there can be used, also, the one having formed thereon a photocatalyst-containing layer side light-shielding portion that has been formed into a pattern.

a. Photocatalyst-Containing Layer

The photocatalyst-containing layer used in the present invention is not particularly limited only if it has a construction wherein the photocatalyst in the layer causes a change in wettability of the change-in-wettability layer it contacts with. The layer may be the one that is constructed using photocatalyst and binder, or the one that has been made using a photocatalyst as simple substance. Also, the wettability of the surface may be hydrophilic or water repellent.

The photocatalyst-containing layer used in the present invention, for example, as illustrated in FIG. 12, may be the one that has been made a photocatalyst-containing layer side substrate 3 by a photocatalyst-containing layer's 2 being formed on the entire surface of the base material member 1. However, the layer, for example, as illustrated in FIG. 13, may be the one that is obtained by a photocatalyst-containing layer's 2 being formed on the base material member in the form of a pattern.

By forming the photocatalyst-containing layer as a pattern in that way, as will later be explained in connection with the photocatalyst treatment process, when radiating light energy with the photocatalyst-containing layer being in contact with the change-in-wettability, there is no need to perform pattern radiation that uses a photo-mask or the like. Namely, by performing radiation of the light energy with respect to the entire surface, a pattern of wettability including a hydrophilic region and water-repellent region can be formed on the change-in-wettability layer.

Although the method of patterning the photocatalyst-containing layer is not particularly limited, it can be executed using a photolithography technique or the like.

Also, since the wettability of only the portion on the change-in-wettability layer in actual contact with the photocatalyst-containing layer changes, the radiation direction of energy may be arbitrary only if the direction enables the energy to be radiated onto the portion of contact between the photocatalyst-containing layer and the change-in-wettability layer. Further, regarding the energy, as well, that is radiated, there is the merit that the energy is not limited to the one that is parallel, such as parallel light.

The acting mechanism of the photocatalyst, in the above-described photocatalyst-containing layer, which is represented by titanium dioxide as later described is not always clear. However, it is considered as being the case that the carrier that has been produced by the radiation of light directly reacts with the compounds in the vicinity of that, or causes the production of active oxygen species in the existence of oxygen and water to thereby cause a change in the chemical structure of the organic material. In the present invention, it is thought that the carrier acts on the compounds in the change-in-wettability layer that contacts with the photocatalyst-containing layer on the same.

As the photocatalyst used in the present invention, there can be taken up as the examples titanium dioxide (TiO₂) that is known as photo-semiconductor, zinc oxide (ZnO), tin oxide (SnO₂), strontium titanic acid (SrTiO₃), tungsten oxide (WO₃), bismus oxide (Bi₂O₃), and iron oxide (Fe₂O₃). By selecting from these compounds, one, or two or more, kinds of them can be used in a form wherein they are mixed.

In the present invention, especially titanium dioxide is suitably used because the band gap energy thereof is high; it is chemically stable and has no toxicity; and it is easy to get. As the titanium dioxide, there are an anatase type one and a rutile type one, either of which can be used in the present invention. However, the anatase type titanium dioxide is more preferable. The anatase type titanium dioxide has an excitation wavelength of 380 nm or less.

As that anatase type titanium dioxide, there can be taken up as the examples anatase type titaniazol of hydrochloric acid peptization type (STS-02 (7 nm in average particle size) produced by Ishihara Sangyo Kaisha, Ltd.) or ST-K01 manufactured by Ishihara Sangyo Kaisha, Ltd.), anatase type titaniazol of nitric acid peptization type (TA-15 (12 nm in average particle size) produced by Nissan Chemical Industries, Ltd.), etc.

The smaller the particle size of the photocatalyst is, the more preferable the photocatalyst is. This is because in that case the photocatalytic reaction more effectively occurs. In more detail, it is preferable to use a photocatalyst the average particle size of which is 50 nm or less, more preferable to use a photocatalyst the average particle size of which is 20 nm or less.

The photocatalyst-containing layer according to the present invention may be the one that is formed using a photocatalyst in an independent form as described above or the one that is formed in a form wherein it is mixed with a binder.

In the case of the photocatalyst-containing layer consisting of only a photocatalyst, the efficiency with which the wettability on the change-in-wettability layer changes is enhanced, namely that is advantageous from the viewpoint of the relevant cost such as shortening the treating length of time. On the other hand, in the case of the photocatalyst-containing layer consisting of a photocatalyst and a binder, there is the merit that forming the photocatalyst-containing layer is easy.

As the method of forming a photocatalyst-containing layer consisting of only a photocatalyst, there can be taken up as the examples the methods each of which uses a vacuum film-making method such as a sputtering method, CVD method, and vacuum deposition method. By forming the photocatalyst-containing layer through the use of a vacuum film-making method, the photocatalyst-containing layer can be made the one the thickness of which is uniform and which contains therein only a photocatalyst. As a result of this, it is possible to uniformly change the wettability on the change-in-wettability layer and, because the layer consists of only a photocatalyst, compared to the case where a binder is used, to cause a change in the wettability on the change-in-wettability layer with a high efficiency.

Also, as the method of forming a photocatalyst-containing layer consisting of only a photocatalyst, as far as the case where the photocatalyst is, for example, titanium dioxide is concerned, there can be taken up as the examples a method that forms amorphous titania on the base material member and then phase-changes it into crystalline titania by baking, etc. The amorphous titania used here can be obtained by performing hydrolysis and dehydration condensation of inorganic salt of titanium such as titanium tetrachloride, titanium sulfate, etc., or by performing hydrolysis and dehydration condensation in the presence of oxygen an organic titanium compound such as tetra-ethoxy titanium, tetra-isopropoxy titanium, tetra-n-proxy titanium, tetra-butoxy titanium, and tetra-methoxy titanium. Subsequently, the amorphous titania can be denatured into anatase type titania by baking done at a temperature of 400° C. to 500° C. and then into rutile type titania by baking done at 600° C. to 700° C.

Also, in the case of using a binder, using the one having a high bond energy, the principal skeleton of that is not decomposed by photo-excitation of the above-described photocatalyst, is preferable, and, there can be taken up as the examples a polysiloxane-based material explained as the materials under the preceding item “Orientation film”, etc.

In a case where using polysiloxane as the binder in that way, the photocatalyst-containing layer can be formed by dispersing into the photocatalyst and polysiloxane binder into a solvent together with additives if necessary and thereby preparing a coating solution and then coating it onto the base material member. As the solvent used, an alcoholic organic solvent such as ethanol, isopropanol, etc. is preferable. The coating can be performed with a known coating method such as spin coating, spray coating, dip coating, roll coating, bead coating, etc. In a case where the relevant material contains therein an ultraviolet ray-hardenable component as the binder, radiating ultraviolet rays is performed to thereby perform hardening treatment of that to enable forming a photocatalyst-containing layer.

Also, the invention can use an amorphous silica precursor as the binder. This amorphous silica precursor is expressed by the general formula SiX₄ and, in this formula, X preferably is a silicon compound such as halogen, methoxy group, ethoxy group, or acetyl group, silanol that is a hydrolytic material thereof, or polysiloxane the average molecular weight of which is 3000 or less.

More specifically, the amorphous silica precursor includes as the examples tetraethoxy silane, tetraisopropoxy silane, tetra-n-propoxy silane, tetrabutoxy silane, and tetramethoxy silane. Also, in that case, the amorphous silica precursor and the photocatalyst particles are uniformly dispersed in a non-aqueous solvent; the resulting material is hydrolyzed using the water content in the air, thereby silanol is formed on the base material member; then the resulting material is subjected to dehydration and condensation/polymerization at normal temperature; and a photocatalyst-containing layer can thereby be formed. If dehydration and condensation/polymerization of silanol are performed at 100° or more, the polymerization degree of silanol can be increased to thereby increase the strength on the surface of the film layer. Also, those bonding agents can be used, individually independently, or in a form wherein two or more kinds of them are mixed together.

The content of the photocatalyst in the photocatalyst-containing layer in the case of using a binder can be set to a range of from 50 to 60% by weight, or preferably to a range of from 20 to 40% by weight. Also, the thickness of the photocatalyst-containing layer preferably is in a range of from 0.05 to 10 μm.

Also, the photocatalyst-containing layer can be made to contain therein a surface activator other than the above-described photocatalyst and binder. Specifically, there can be taken up as the examples a hydrocarbon-based nonionic surface activator such as respective series of NIKKOL, BL, BC, BO, and BB that are produced by Nikko Chemicals Co. Ltd. or a fluorine-based, or silicone-based, nonionic surface activator such as ZONYL, FSSN, and FSO that are produced by Du Pont Kabushiki Kaisha, Surflon S-141, 145 that are produced by Asahi Glass Company Megafuck F-141, 144 that are produced by Dainippon Ink and Chemicals, Incorporated, Phthagent F-200, F251 that are produced by Neos, UNIDYNEDS-401, 402 that are produced by DAIKIN INDUSTRIES, Ltd., and Fluorad FC-170, 176 that are produced by 3M. Also, it is also possible to use a cationic surface activator, anionic surface activator, or ampholytic surface activator.

Other than the above-described surface activators, there can also be contained in the photocatalyst-containing layer oligomer such as polyvinyl alcohol, unsaturated polyester, acrylic resin, polyethylene, diallyl phthalate, ethylene propylene diene monomer, epoxy resin, phenol resin, polyurethane, melamine resin, polycarbonate, polyvinyl chloride, polyamide, polyimide, styrene butadiene rubber, chloropulene rubber, polypropylene, polybutylene, polystyrene, polyvinyl acetate, polyester, polybutadiene, polybenzimidazole, polyacrylnitryl, epichlorohydrin, polysulfide, or polyisoprene, or polymer, or etc.

b. Base Material Member

In the present invention, as illustrated in FIG. 12, the photocatalyst-containing layer side substrate 3 is the one that has at least a base material member 1 and a photocatalyst-containing layer 2 formed on the base material member 1.

At this time, the material constituting the base material member that is used for the substrate is suitably selected depending on the radiation direction of energy in the photocatalyst treatment process that will be described later. Namely, in a case where, in the photocatalyst treatment process as later described, performing exposure from the rear surface of the photocatalyst-containing layer side substrate, the material needs to be transparent material. However, in a case where exposure is performed from the change-in-wettability layer side, the material is not particularly limited to transparent material.

Also, the base material member used in the present invention may be the one that has flexibility such as a resinous film or the one that has no flexibility such as a glass substrate. The material of the base material member, also, is suitably selected depending on the energy radiation method in the photocatalyst treatment process as later described.

Like that, the base material member used in the photocatalyst-containing layer side substrate in the present invention is not particularly limited in terms of material. However, since the photocatalyst-containing layer side substrate is repeatedly used, a material that has a prescribed level of physical strength and the surface of that has excellent adhesion to the photocatalyst-containing layer is preferable.

In more detail, there can be taken up as the examples glass, ceramic, metal, plastic, etc.

Incidentally, to enhance the adhesion between the surface of the base material member and the photocatalyst-containing layer, a primer layer may be formed on the base material member. As that primer layer, there can be taken up as the examples silane-based coupling agent, titanium-based coupling agent, etc.

c. Photocatalyst-Containing Layer Side Light-Shielding Portion

As the photocatalyst-containing layer side substrate used in the present invention, there may be used the one having formed with respect thereto a photocatalyst-containing layer side light-shielding portion formed into the configuration of a pattern. By using the photocatalyst-containing layer side substrate that has the photocatalyst-containing layer side light-shielding portion like that, when performing exposure, there is no need either to use a photo-mask or to perform depiction radiation that uses a laser light. Since, accordingly, there is no need to perform positional alignment of the photo-mask with the photocatalyst-containing layer side substrate, the relevant process of exposure can be made simple, nor is there any need to use an expensive device necessary for performing depiction radiation. Therefore, there is the merit that using the substrate becomes advantageous in terms of the relevant cost.

As that photocatalyst-containing layer side substrate that has the photocatalyst-containing layer side light-shielding portion, the following two embodiments can be adopted depending on the formation position where the photocatalyst-containing layer side light-shielding portion is formed.

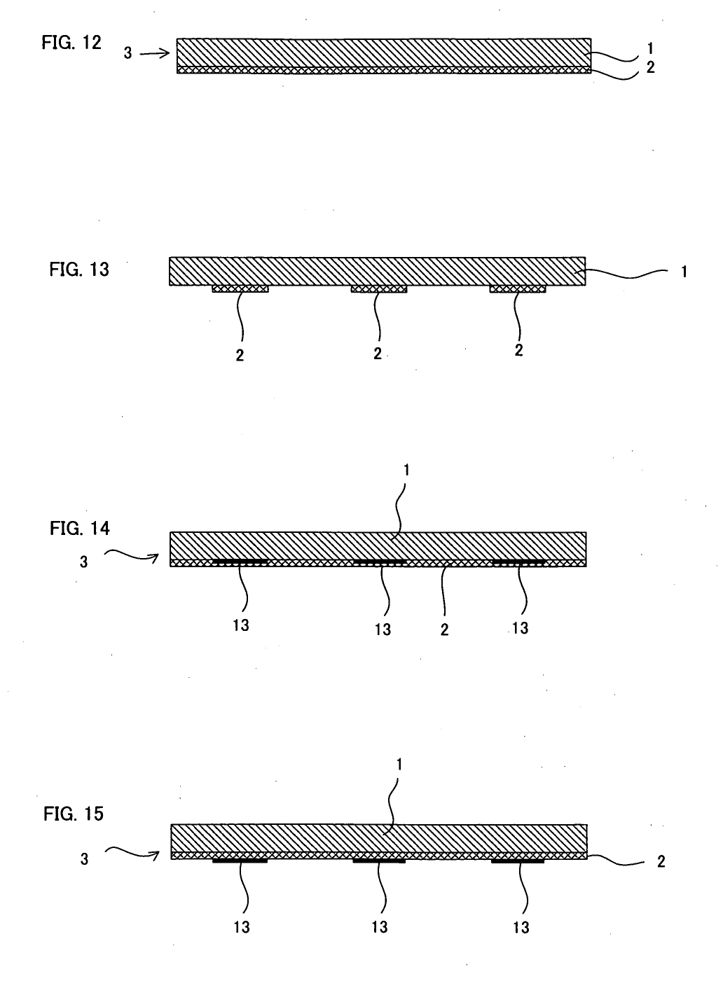

One is the embodiments wherein, as illustrated in, for example, FIG. 14, the photocatalyst-containing layer side light-shielding portion 13 is formed on the base material member 1; and on this light-shielding portion 13 there is formed the photocatalyst-containing layer 2 to make the resulting mass the photocatalyst-containing layer side substrate 3. The other is a mode of embodiment wherein, as illustrated in, for example, FIG. 15, the photocatalyst-containing layer 2 is formed on the base material member 1; and on the member there is formed the photocatalyst-containing layer side light-shielding portion 13 to make the resulting mass the photocatalyst-containing layer side substrate 3.

In either embodiment, compared with the case where using a photo-mask, the photocatalyst-containing layer side light-shielding portion comes to be disposed in the vicinity of the portion of contact between the photocatalyst-containing layer and the change-in-wettability layer. This can lessen the effect of the scattering of the energy within, for example, the base material member, which enables performing pattern radiation of energy very accurately.

Further, in the embodiment that forms the photocatalyst-containing layer side light-shielding portion on the photocatalyst-containing layer, when disposing the photocatalyst-containing layer and the change-in-wettability layer with a prescribed gap intervening therebetween, the thickness of the photocatalyst-containing layer side light-shielding portion can be made to coincide with the dimension of that prescribed gap beforehand if it is preferable that those both be disposed with a prescribed gap intervening therebetween as later described. By doing so, the merit comes up that the photocatalyst-containing layer side light-shielding portion can be used as the spacer for making that prescribed gap a fixed one.

Namely, by, when disposing the photocatalyst-containing layer and the change-in-wettability layer with a prescribed gap in between, disposing the photocatalyst-containing layer side light-shielding portion and the change-in-wettability layer in a state of these layers' being made to adhere to each other, the prescribed gap becomes able to be made accurate in terms of the dimension. Further, by radiating energy, in that state, from the photocatalyst-containing layer side substrate, the pattern of wettability becomes able to be formed on the change-in-wettability layer with a high accuracy.

The method of forming such photocatalyst-containing layer side light-shielding portion is not particularly limited but is suitably selected and used according to the property of the formation surface where formation is made of the photocatalyst-containing layer side light-shielding portion, the shielding property with respect to energy needed, etc.

For instance, a method may be adopted of forming a metallic thin film such as chrome, the thickness of which is to an extent of 1000 to 2000 Å, with the use of a sputtering method, vacuum deposition method, etc. and then patterning the thin film. This patterning method may be an ordinary patterning method such as sputtering.

The above-described forming method may be the one wherein a layer that has been prepared by causing containing into a resinous binder of light-shielding particles such as carbon fine particles, metal oxide, inorganic pigment, organic pigment, etc. is formed into a pattern. As the resinous binder used, there can be used a material obtained by mixing together one, or two or more, kinds of resins such as polyimide resin, acrylic resin, epoxy resin, polyacrylamide, polyvinyl alcohol, gelatin, casein, cellulose, etc., photosensitive resin, or O/W emulsion type resinous composition such as the one prepared by converting a reactive silicone into an emulsion. The thickness of the resin-made light-shielding portion can be set to a value falling within a range of from 0.5 to 10 μm. As the method of patterning the resin-made light-shielding portion, there can be used a method such as photolithography, printing, etc. that is generally used.

Incidentally, although in the above-described explanation it has been, as the formation position where formation is made of the photocatalyst-containing layer side light-shielding portion, given of two cases one of which is the case where that position is located between the base material member and the photocatalyst-containing layer and the other of which is the case where that position is located on the surface of the photocatalyst-containing layer, other than this it is also possible to adopt an embodiment wherein the photocatalyst-containing layer side light-shielding portion is formed on the surface of the base material member that is on a side where no photocatalyst-containing layer is formed. As the embodiment, a method wherein, for example, a photo-mask is made to adhere to the surface to an extent that permits it to be removably attached thereto, etc. is thought available and, in this case, the method can be used for example when causing a change of the wettability pattern in a small lot.

3. Photocatalyst Treatment Process

In the present invention, next, the photocatalyst treatment process is executed wherein the photocatalyst-containing layer and the change-in-wettability layer are disposed in the way of their being contacted with each other and thereafter energy is radiated onto the resulting mass from a prescribed direction to thereby form a wettability pattern including a hydrophilic region and a water-repellent region on the surface of the change-in-wettability layer.

a. Disposing Photocatalyst-Containing Layer and Change-in-Wettability Layer

In this process, first, when performing radiation of energy, the photocatalyst-containing layer and the change-in-wettability layer are disposed with a gap of 200 μm or less intervening in between.

In the present invention, that gap may not be provided and the photocatalyst-containing layer and the change-in-property layer may be made to adhere to each other. However, considering the pattern accuracy and the aspect of increasing the efficiency of changing the property of the change-in-property layer, the gap preferably is set to fall within a range of 100 μm or less, especially a range of from 0.2 μm to 10 μm.

By disposing the photocatalyst-containing layer and the surface of the change-in-property layer with a prescribed gap in between in the above-described way, the oxygen and the water as well as the active oxygen species produced due to the photo-catalytic action become easier to detach or attach. Namely, in a case where making the gap between the photocatalyst-containing layer and the change-in-property layer narrower than a value falling within the above-described range, the active oxygen species comes to have more difficulty of detaching or attaching. As a result of this, there is the possibility that the speed at which the property is changed will be slowed down. From this point of view, the case is unpreferable. In a case where the disposition is made with the gap in between the dimension of which is greater than a value falling within that range, the active oxygen species produced becomes more difficult to reach the change-in-property layer. In this case as well, there is the possibility that the speed at which the property is changed will be slowed down. From this point of view, the case also is unpreferable.

In the present invention, the disposition condition in which the above-described gap intervenes in between needs only to be maintained at least during the exposure.

As the method of disposing the photocatalyst-containing layer and change-in-wettability layer with the gap being uniformly provided which is very narrow as described above, there can be taken up as the example a method wherein a spacer is used. Further, by using the spacer like that, it is possible to form a uniform gap. In addition, since the portion that the spacer contacts with acts to prevent the photocatalytic action from extending to the surface of the change-in-wettability layer, a prescribed pattern of wettability becomes able to be formed on the change-in-wettability layer by forming this spacer so that it may have a pattern similar to the wettability pattern described above.

In the present invention, although that spacer may be formed as a separate, single member, for simplifying the process it is preferable that, as has been explained under the preceding item “Photocatalyst-containing layer side substrate-preparing process”, the space be formed on the surface of the photocatalyst-containing layer of the photocatalyst-containing layer side substrate. Incidentally, in the explanation made in the photocatalyst-containing layer side substrate-preparing process, the spacer was explained as the photocatalyst-containing layer side light-shielding portion. However, in the present invention, because the spacer may be the one that needs only to have a function to protect the surface of the change-in-wettability layer so as to prevent the photocatalytic action from extending to it, the spacer may be the one that is formed using a material having no function to shield energy that is to be radiated.

b. Radiating Energy Onto the Gap Portion

Next, in the state where the both layers are disposed with the above-described gap in between is maintained as is, radiation of energy is performed with respect to the gap portion. Incidentally, the wording “radiation of energy (exposure)” referred to in the present invention is a concept that includes any radiation of energy that enables a change in wettability of the surface of the change-in-wettability layer by the photocatalyst-containing layer, and that is not limited to energy of a visible light.

Ordinarily, the wavelength of light used for the exposure is set from a range of 400 nm or less, preferably from a range of 380 nm or less. This is because the preferable photocatalyst used in the photocatalyst-containing layer is titanium dioxide as described above and, if this titanium is used, as the energy that activates the photocatalytic action a light having the wavelength is preferable.

As the light source that can be used for the exposure, there can be taken up as the examples a mercury lamp, metal halide lamp, Xenon lamp, excimer lamp, and other various kinds of light sources.

In addition to the methods that perform pattern radiation via a photo-mask using above-mentioned light sources, it is also possible to use the method that performs depiction radiation as a pattern by using laser light such as an excimer, YAG etc.

Also, the radiating amount of energy that is used when performing exposure is defined as being the one that is needed for the surface of the change-in-wettability layer to have its wettability changed due to the action of the photocatalyst in the photocatalyst-containing layer.

At this time, by performing exposure while heating the photocatalyst-containing layer, the sensitivity becomes able to be increased. That, therefore, is preferable because efficiently changing the wettability can be performed. Specifically, heating within a range of from 30° C. to 80° C. is preferable.

The exposure direction in the present invention is determined depending on the method of forming the wettability such as whether or not the photocatalyst-containing layer side light-shielding portion is formed, or depending on whether the photocatalyst-containing layer side substrate is transparent.

Namely, in a case where the photocatalyst-containing layer side light-shielding portion is formed, there is the need for exposure to be done from the photocatalyst-containing layer side substrate side and, in addition, in that case, there is the need for the photocatalyst-containing layer side substrate to be transparent with respect to the energy that is radiated. Incidentally, in this case, if the photocatalyst-containing layer side light-shielding portion is formed on the photocatalyst-containing layer and, in addition, the light-shielding portion is used in the way of its having a function as the spacer as stated before, the exposure direction may be from the photocatalyst-containing layer substrate side or from the for-pattern-formation substrate side.

Also, the exposure direction when the photocatalyst-containing layer is formed as a pattern may be any given one only if energy is radiated onto the gap portion between the photocatalyst-containing layer and the change-in-wettability layer as described above.

Similarly, in a case, as well, where using the above-described spacer, the exposure direction may be any given one only if energy is radiated onto the portion of gap.

If using a photo-mask, energy is radiated from the side where it is disposed.

c. Removing Photocatalyst-Containing Layer Side Substrate

When the above-described radiation of energy finishes being performed, the photocatalyst-containing layer side substrate is taken away from the position of its being opposed to the change-in-wettability layer, whereby a pattern of wettability including a hydrophilic region and a water-repellent region is formed on the change-in-wettability layer.

4. Etceteras

Regarding the other respects in the present invention, such as, for example, the matter on the water-repellent region and the hydrophilic region, they are the same as those that were explained under the preceding item “A. Orientation film” and therefore an explanation relevant thereto is omitted here.

C. Substrate with Orientation Film

Next, an orientation film-equipped substrate according to the present invention will be explained. The orientation film-equipped substrate according to the present invention is characterized by having a substrate and an orientation film that is formed on the substrate and that has a pattern including a water-repellent region and a hydrophilic region that is a region where the angle of contact with water is smaller than that in the water-repellent region. By having the orientation film wherein the hydrophilic region is formed within the water-repellent region as a pattern, in a case of having used the resulting substrate in, for example, the liquid crystal display device in vertical orientation mode, it becomes possible to perform orientation division within the relevant pixel of the liquid crystal molecule that has vertically been oriented. Namely, that becomes possible through utilizing the nature of the liquid crystal molecule that this liquid-crystalline molecule that within the water-repellent region is vertically oriented gets inclined when within the hydrophilic region.

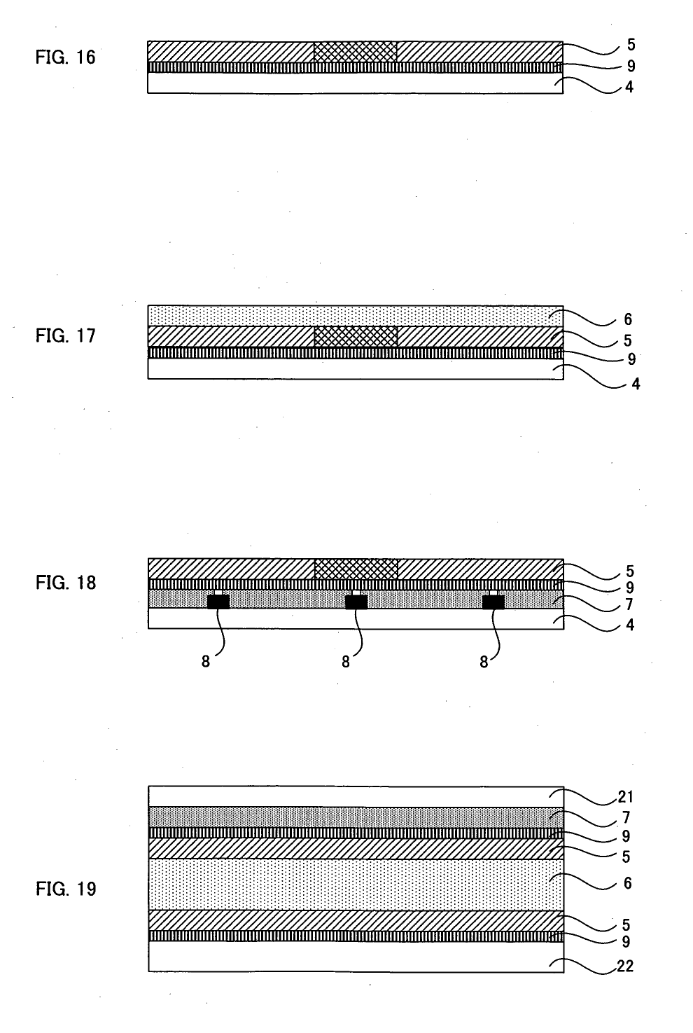

FIG. 16 illustrates an example of the above-described orientation film-equipped substrate according to the present invention, i.e. illustrates a state where the orientation film 5 is formed on the substrate 4 via a transparent electrode layer 9.

The orientation film used in the orientation film-equipped substrate according to the present invention is the same as that which has been explained under the preceding item “A. Orientation film”. Therefore, an explanation relevant thereto is omitted here.

Also, the substrate used in the present invention ordinarily is a transparent substrate and may be the one such as glass that has no flexibility or the one such as transparent resin that has flexibility.

As illustrated in, for example, FIG. 17, in the present invention, ordinarily, a liquid crystal layer 6 is disposed on the side of the surface of the orientation film.

Incidentally, by utilizing the orientation film of the present invention, it is also possible to form a semi-transparent reflective film using a technique of orienting and hardening a hardenable cholesteric liquid crystal (e.g. a mixture of hardenable nematic liquid crystal and hardenable kairal agent) Also, using a hardenable nematic liquid crystal, hardenable short-pitch cholesteric liquid crystal, or hardenable discotic liquid crystal, as above, it is possible to orient and harden it with the orientation film of the present invention to form a difference-in-phase layer having an index of double refraction and use it as an optical compensation sheet.

For the liquid-crystalline molecule, which is a negative type liquid-crystalline material having a negative dielectric constant anisotropy, used in the above-described liquid crystal layer, the material is not particularly limited if at normal temperature it is the one having a nematic phase. Specifically, there can be taken up as the examples MLC-6608, MLC-2037, MLC-2038, and MLC-2039 (each of that is a trade name) of Merck & Co., Inc.

The orientation film-equipped substrate of the present invention may be the one wherein other layers are formed between the substrate and the orientation film. Or it may be the one wherein, as illustrated in, for example, FIG. 18, a colored layer 7 and a light-shielding portion (black matrix) 8 formed at the boundary portion thereof are provided on a substrate 4; on the color layer 7 and the light-shielding portion 8 there is provided the transparent electrode layer 9; and on the layer 9 there is formed the orientation film 5, etc.

The above-described colored layer and light-shielding portion used in the present invention is not particularly limited if they are the ones that are ordinarily used in the color filter. For the colored layer, a photosensitive resin that contains therein a red, blue, or green pigment that is used in an ordinary technique of pigment dispersion, etc. is suitably used. For the light-shielding portion, metal such as chrome, a resin having dispersed therein particles having light-shielding property such as carbon black, etc. are suitably used.

Also, the transparent electrode layer is not particularly limited, but, generally, ITO is suitably used.

D. Liquid Crystal Display Device

Finally, the liquid crystal display device of the present invention will be explained. The liquid crystal display device of the present invention is characterized by comprising:
a color filter side substrate that has a first substrate, a colored layer that is formed on the first substrate, a transparent electrode layer formed on the colored layer, and an orientation film that is formed on the transparent electrode layer and that has on its surface on a side where a liquid crystal layer is contacted therewith a pattern including a water-repellent region and a hydrophilic region that is a region where the angle of contact with water is smaller than that in the water-repellent region, and
an opposing substrate that has a second substrate, a transparent electrode layer formed on the second substrate, and an orientation film that is formed on the surface of the transparent electrode layer and that has on its surface on a side where a liquid crystal layer is contacted therewith a pattern including a water-repellent region and a hydrophilic region that is a region where the angle of contact with water is smaller than that in the water-repellent region,
whereby the orientation film of the color filter side substrate and the orientation film of the opposing substrate are disposed in the way they oppose each other; and
liquid crystal is sealed into between the two orientation films.

The liquid crystal display device mentioned like that is the one that has an orientation film wherein the hydrophilic region is formed within the water-repellent region as a pattern. Therefore, in, for example, the liquid crystal display device in vertical orientation mode, the orientation division within the pixel of the liquid crystal molecule that has vertically been oriented becomes able to be made by the nature of the liquid crystal molecule that this molecule that within the water-repellent region is vertically oriented gets inclined within the hydrophilic region.

An example of the above-described liquid crystal device is illustrated in FIG. 19. First, the color filter side substrate having formed therein a color filter has the first substrate 21 on which there is formed the colored layer 7 that ordinarily has a pattern of red, green, and blue. Further, on that surface there is formed the transparent electrode layer 9 and, further, on the surface of the resulting structure, there is formed the orientation film 5 as stated above.

On the opposing substrate that opposes the color filter side substrate has the second substrate 22, on which the transparent electrode 9 is formed, on which the above-described orientation film 5 is formed.

Incidentally, either the transparent electrode layer of the color filter side substrate or the transparent electrode layer of the opposing substrate side may be the one that has been formed in the mode of active matrix.

The orientation film 5 of the color filter side substrate and the orientation film 5 of the opposing substrate side are disposed in the way of their opposing each other. Further, into the gap between these two films there are sealed the liquid crystal molecules. As a result of this, a liquid crystal layer 6 is formed. The structure that has thus been obtained is made the liquid crystal device of the present invention.

The above-described orientation film used in the liquid crystal display device according to the present invention is the same as that which has been explained in connection with the preceding item “A. Orientation film”, so an explanation relevant thereto is omitted. Also, the other first and second substrates are the same as that which has been explained in connection with the preceding item “C. Substrate with orientation film” and, further, regarding the colored layer and transparent electrode layer as well and, further, regarding the liquid crystal layer as well, each of them is the same as that which has been explained under the preceding item “C. Substrate with orientation film”, so an explanation relevant thereto is omitted.

It is to be noted that the present invention is not limited to the above-described embodiment. The above-described embodiment is only illustrative. The changes or modifications that have substantially the same constructions as those which are made using the technical ideas described in the claimed scope of the present invention and exhibit the same functions and effects are included in the technical scope of the present invention whatever kinds they may be of.

### EXAMPLES

Hereinafter, the present invention will concretely be explained using Examples.

### Example 1

First, an orientation film was coated (applied) onto each of upper and lower substrates and, as the orientation film of the lower side substrate, the one that has formed thereon a wettability pattern having a water-repellent region and hydrophilic region was used.

The orientation film was prepared as follows. On a quartz glass substrate having formed thereon a pattern of light-shielding layer made of chrome, there was coated a for-use-as-photocatalyst titanium oxide coating material ST-K03 produced by Ishihara Sangyo Kaisha, Ltd. The resulting mass was dried at 150° C. for 15 minutes to complete a photo-mask with photocatalyst-containing layer (a pattern-equipped substrate).

Next, 3 grams of an 0.1N aqueous solution of hydrochloric acid was added to a mixture of 5 grams of fluoroalkyl silane and 2 grams of tetraethoxy silane and the resulting mass was stirred at room temperature for 1 hour to prepare a solution. The solution was coated onto the substrate and the resulting substrate was dried at 150° C. for 10 minutes to form a change-in-wettability layer.

Onto the resulting substrate, there was adhered the above-described photo-mask. Then, using an ultrahigh mercury lamp, ultraviolet rays were radiated onto the resulting mass from the photo-mask side, at an illuminance of 20 mW/cm² (365 nm), for 180 seconds, to thereby form a pattern of wettability on the surface of the change-in-wettability layer. At this time, the angle of contact with water at the non-exposed portion was 108° while the angle of contact with water at the exposed portion was 7°. The gap between the substrates was 5 μm. Incidentally, this gap was controlled using a spacer that was disposed in the liquid crystal layer and that gap was almost uniform within the display panel surface. As the spacer, there was used an SP series produced by Fine Chemicals Division, Sekisui Chemical Co., Ltd.

Between the substrates, a thermo-hardenable sealing material was coated on each of their outer-peripheral surfaces, and then they were bonded together. For controlling the gap between the substrates, the cell was heated while being pressed, thereby the seals were cured. As the sealing material, there was used XN-54 produced by Mitsui Chemicals Inc. Into that cell, a liquid crystal material was filled with the use of a vacuum injection technique. As the liquid crystal material there was used an MLC 6608 (trade name) material produced by Merck & Co., Inc. This liquid crystal has negative dielectric anisotropic property and has the nature that, when an electric field is applied, its molecular long axis gets vertically oriented with respect to the direction in which the electric field is formed.

In FIG. 7 illustration is made of a state of no electric field's being applied, a state of a voltage's that is intermediate being applied, and a state of an electric field's being applied, of the liquid crystal display device obtained as above.

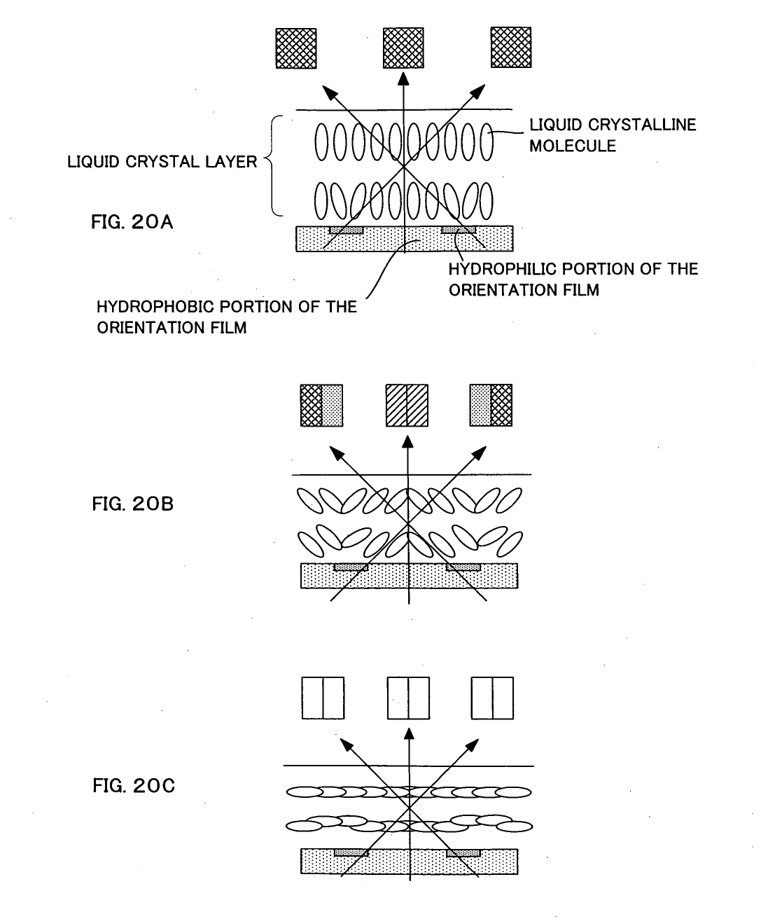

FIG. 20A illustrates an oriented state when no electric field is applied. In this case, since the orientation film of each of the upper/lower substrates exhibits substantially hydrophobic property, the liquid crystal molecule is substantially vertically oriented. In the orientation film hydrophilic region of the lower substrate and in the vicinity thereof, the liquid crystal molecule is oriented in a state of its being somewhat inclined but this inclination is almost near to a state of verticalness. Therefore, even when the incident light passes through the liquid crystal layer, the plane of polarization does not change and the light is absorbed into a polarizing plate of the outgoing side. Resultantly, a display in black was obtained.

FIG. 20B is a view illustrating a state where there has been applied a voltage that causes the liquid crystal to come to a state of its inclined orientation's being intermediate between the horizontal orientation and the vertical orientation. That state results in a display in half tone. In the hydrophilic region of the orientation film, with the molecule that is previously inclined being the starting point, the directions in which the molecules are inclined are determined, and thereby their orientation is divided. Since the regions wherein the inclinations of the liquid crystal molecules differ are formed a plurality of pieces within the relevant pixel, the difference in the passing amount of light that results from the difference in the viewing angle was complementarily averaged, with the result that the dependency on the viewing angle became better.

FIG. 20C illustrates a state where a voltage is sufficiently applied and the liquid crystal is almost horizontally oriented. In this case, a display in white was made.

### Example 2

### Polyimide-Made Orientation Film

As the vertical orientation film material, there were used JALS-688, JALS-204, JALS-2021, and JALS-2022 produced by JSR. and SE-751L and SE-1213 produced by Nissan Chemical Industries, Ltd. Using a spin-coating technique, onto the ITO-equipped glass substrate there was coated each of the above-described PI's, and the resulting mass was baked at 220° C. for one hour.

Spin coating was performed for 5 seconds at 600 rpm and subsequently for 15 seconds at 2400 rpm. The thickness of the orientation film was measured using a direct-needle type film thickness meter, the result of which was 600 Å. Although that polyimide film was a hydrophobic film, by performing ultraviolet-ray exposure through the intermediary of the exposure mask having the photocatalyst-containing layer coated on its uppermost surface, a pattern of hydrophilic region could be formed within the hydrophobic region.

In this Example, a mass wherein the photocatalyst-containing layer is formed on the exposure mask that has a light-shielding region in stripes each 50 μm in width and a light-passing region in stripes each 25 μm in width was used as the orientation film substrate.

As a result, a hydrophobic region 50 μm in width and a hydrophilic region 25 μm in width were formed on the substrate. The angle of contact with water that is on the surface of the hydrophobic region was 96°, namely a sufficiently high level of water repellency was exhibited. Also, exposure was performed via the substrate having the photocatalyst-containing layer with no light-shielding pattern thereon and, in this case, in the portions where the hydrophilic region was made, since the angle of contact with water changes within a range of from approximately 10° to approximately 30°, it was observed that the level of wettability was sufficiently changed and the relevant portions were sufficiently made hydrophilic.

The above-described substrate and another substrate having disposed therein the same vertical-orientation polyimide were positionally aligned with each other and bonded together. At this time, in order to make the gap between the substrates almost 5 μm, an SP series material produced by Fine Chemicals Division, Sekisui Chemical Co., Ltd. was spread over the other substrate. Regarding the spread density, it was controlled so as to become approximately 10 to 200 pieces/mm2. The spreading method was executed using a dry-spreading technique.

In order to ensure the attainment of the adhesion between the upper and the lower substrate as well as the closed space into which liquid crystal is to be filled, sealing material was coated onto the outer-peripheral part of each of the substrates to a width of substantially 1 mm. Then, the resulting structures were subjected to pressing and then each sealant was thermo-hardened.

A negative type liquid crystal material of MLC-6608 that is produced by the Merck & Co., Inc. was injected into the resulting structure to prepare a liquid crystal cell. When observing with a polarizing microscope, the initial orientation was obtained as the vertical orientation. Further, when applying a voltage to that liquid crystal cell, there was observed a state where the liquid crystal director was laid substantially parallel with the boundary between the hydrophilic region and the hydrophobic region. When a sufficiently high level of voltage was applied, the horizontal orientation wherein the director was laid alongside that boundary was obtained.

### Example 3

### IPS Mode

The IPS mode is a horizontally oriented liquid crystal mode, and horizontal-orientation processing is performed with respect to the substrate. In this Example, as the change-in-wettability layer, there was used fluorine-based silicone, and, by designing the region occupied by the hydrophilic property to an area that is equal to or greater than that corresponding to the region occupied by the hydrophobic property, the horizontal orientation was obtained.

Using a spin coating technique, a fluorine-based silicone that had been used in Example 1 was coated onto the ITO-equipped glass substrate to form a relevant film. Although this fluorine-based silicone film is a hydrophobic film, by performing ultraviolet-ray exposure with respect to it via the exposure mask having the photocatalyst-containing layer coated on its uppermost surface, a pattern of hydrophilic region and hydrophobic region could be disposed on the substrate. This pattern is illustrated in FIG. 6. In this Example, the photocatalyst layer is formed on the exposure mask having a light-shielding region in stripes each 20 μm in width and a light-passing region in stripes each 20 μm in width.

Concretely, as illustrated in FIG. 6, a hydrophobic region 20 μm in width and a hydrophilic region 20 μm in width were formed on the substrate.

The fluorine-based silicone film has a sufficient level of water repellency when the angle of contact with water thereof is around 110 degrees. Also, when exposure is performed via the substrate that has the photocatalyst-containing layer with no light-shielding pattern to form a hydrophilic region, the angle of contact with water changes within a range of from approximately 0 to approximately 10°, for which reason, it was observed that the wettability sufficiently changed and the film was made sufficiently hydrophilic.

The above-described substrate was positionally aligned with another substrate having disposed therein the same pattern of hydrophilicity and was bonded or adhered thereto. At this time, for making the gap between the substrates approximately 3 to 4 μm, SP series produced by Fine Chemicals Division, Sekisui Chemical Co., Ltd. was spread with respect to the other substrate.

Regarding the density of spreading, it was controlled so that it may be 10 to 200 pieces/mm² or so. For ensuring the adhesion between the upper and the lower substrate as well as the closed space into which liquid crystal is to be filled, sealing material was coated onto the outer-peripheral part of each substrate to a width of approximately 1 mm. After the sealant was pressed, it was thermo-hardened.

A liquid material of MLC-2042 for IPS produced by Merck & Co., Inc. was injected to prepare a liquid crystal cell. When the resulting structure was observed using a polarizing microscope, a state where the director got substantially parallel with the boundary between the hydrophilic region and the hydrophobic region was observed.

Further, the state was observed where the liquid crystal director within the liquid crystal cell was coming, according to the intensity of the electric field applied, near to the electric lines of force direction of the electric field applied.

### Example 4

### TN Mode

The surface of the substrate in TN mode is a horizontally oriented liquid crystal mode, and horizontal orientation processing is executed with respect to the substrate. In this Example, for the change-in-wettability layer, there was used the fluorine-based silicone that had been used in Example 1.

Designing was done in the way that the region occupied by hydrophilicity was equal to or greater than the region occupied by hydrophobicity, and, horizontal orientation processing was executed with respect to the resulting mass. Thereby, a cell illustrated in FIG. 9, which was configured in the way that the orientation direction of the upper substrate and that of the lower substrate intersected each other at a right angle, was prepared.

Using a spin coating technique, a fluorine-based silicone that had been used in Example 1 was coated onto the ITO-equipped glass substrate to form a relevant film. This fluorine-based silicone film was a hydrophobic film. On the other hand, by performing ultraviolet-ray exposure with respect to it via the exposure mask having the photocatalyst-containing layer coated on its uppermost surface, a hydrophilic region and hydrophobic region could be disposed on the substrate. In this Example, the photocatalyst layer was formed on the exposure mask having a light-shielding region in stripes each 20 μm in width and a light-passing region in stripes each 20 μm in width.

Using the resulting mass, a hydrophobic region 20 μm in width and a hydrophilic region 20 μm in width were formed on the substrate. The fluorine-based silicone film has a sufficient level of water repellency when the angle of contact with water thereof is around 110 degrees. Also, when exposure is performed via the substrate that has the photocatalyst-containing layer with no light-shielding pattern, the angle of contact with water changes within a range of from approximately 0 to approximately 10°, for which reason, it was observed that the wettability sufficiently changed and the film was made sufficiently hydrophilic.

The above-described substrate was positionally aligned with another substrate having disposed therein the same pattern of hydrophilicity and was bonded or adhered thereto. At this time, for making the gap between the substrates approximately 4 to 5 μm, SP series produced by Fine Chemicals Division, Sekisui Chemical Co., Ltd. was spread with respect to the other substrate.

Regarding the density of spreading, it was controlled so that it maybe 10 to 200 pieces/mm² or so. For ensuring the adhesion between the upper and the lower substrate as well as the closed space into which liquid crystal is to be filled, sealing material was coated onto the outer-peripheral part of each substrate to a width of approximately 1 mm. After the sealant was pressed, it was thermo-hardened.

A liquid material of MLC-2042 for TN produced by Merck & Co., Inc. was injected to prepare a liquid crystal cell. When the resulting structure was observed using a polarizing microscope, the action that the director got substantially parallel with the boundary between the hydrophilic region and the hydrophobic region occurred in the upper and the lower substrate. Further a state where the director was twisted 90° in the thickness direction of the liquid crystal layer was observed.

Further, the state was observed where the liquid crystal director within the liquid crystal cell was coming, according to the intensity of the electric field applied, near to the electric lines of force direction of the electric field applied to get vertical with respect to the substrate.

### Example 5

### MVA Mode

Vertical orientation processing is executed with respect to the surface of the substrate in MVA mode. In this Example, for the change-in-wettability layer, there was used a fluorine-based silicone. Also, designing was done in the way that the region occupied by hydrophobicity was equal to or greater than the region occupied by hydrophilicity, and, vertical orientation processing was executed with respect to the resulting mass.

Also, the surface of each of the upper and the lower substrate was designed to have a pattern configuration of hydrophilic property for giving a region where the liquid crystal is inclined beforehand in a prescribed direction, or a region where the liquid crystal is likely to be inclined in a prescribed direction, as illustrated in FIG. 3.

In this Example, isosceles-triangular regions the bottom side of that is 20 μm and the height of that is 10 to 50 μm were disposed at intervals of 10 to 50 μm. The pattern was prepared in the way that the respective forward ends of the isosceles-triangular regions were distributed in four directions within the substrate region. Regarding the disposition pattern of the isosceles triangle, it was disposed alongside, and in the vicinity of, the ridge of the rib in the MVA mode and, regarding the direction of the forward end of the isosceles triangle, it was disposed in the way that it opposed the ridge. This is because utilizing the nature that each liquid crystal molecule in the vicinity of the forward end of the isosceles triangle gets inclined to the hydrophilic region when an electric field has been applied.

Using a spin coating technique, a fluorine-based silicone described above was coated onto the ITO-equipped glass substrate to form a relevant film. This fluorine-based silicone film was a hydrophobic film. By performing ultraviolet-ray exposure with respect to it via the exposure mask having the photocatalyst-containing layer coated on its uppermost surface, a hydrophilic region and hydrophobic region could be disposed on the substrate. The fluorine-based silicone film had a sufficient level of water repellency when the angle of contact with water thereof was around 110 degrees.

Also, when exposure is performed via the substrate that has the photocatalyst-containing layer with no light-shielding pattern, the angle of contact with water changes within a range of from approximately 0 to approximately 10°, for which reason, it was observed that the wettability sufficiently changed and the film was made sufficiently hydrophilic.

The above-described substrate was positionally aligned with another substrate having disposed therein the same pattern of hydrophobicity and hydrophilicity and was bonded or adhered thereto. At this time, for making the gap between the substrates approximately 3.5 to 4.5 μm, SP series produced by Fine Chemicals Division, Sekisui Chemical Co., Ltd. was spread with respect to the other substrate.

Regarding the density of spreading, it was controlled so that it may be 10 to 200 pieces/mm² or so. For ensuring the adhesion between the upper and the lower substrate as well as the closed space into which liquid crystal is to be filled, sealing material was coated onto the outer-peripheral part of each substrate to a width of approximately 1 mm. After the sealant was pressed, it was thermo-hardened.

A negative type liquid material of MLC-6608 produced by Merck & Co., Inc. was injected to prepare a liquid crystal cell. When the resulting structure was observed using a polarizing microscope, the initial orientation was obtained as the vertical orientation. Further, when a voltage was applied to the liquid crystal cell, there was observed a state where the director got inclined from the triangular hydrophilic region to the orthogonal direction.

Further, because the acute forward end of each triangle within the region is directed in any one of the four directions, there was observed the divided into 4 division orientation wherein the region was distributed into the ones wherein the liquid crystal molecules got inclined with their four inclinations.

1. An orientation film comprising a pattern, on its surface of a side where a liquid crystal layer is contacted, that includes a water-repellent region and a hydrophilic region that is a region where the angle of contact with water is smaller than that in the water-repellent region.

2. An orientation film according to claim 1, wherein the angle of contact with water in the water-repellent region is greater by an angle falling within a range of from 10° to 120° than that in the hydrophilic region.

3. An orientation film according to claim 1, wherein the angle of contact with water in the water-repellent region falls within a range of from 40° to 120°.

4. An orientation film according to claim 1, wherein the orientation film comprises a compound that has polyimide, polyamide, or organopolysiloxane as the principal chain and has as the side chain linear alkyl group, or fluorine-containing alkyl group, the number of carbons of that is from 4 to 22 inclusive; and the density of the side chains in the water-repellent region is lower than that of the side chains in the hydrophilic region.

5. An orientation film according to claim 4, wherein, in the water-repellent region, the weight of the side chains is 5% by weight or more based upon the total weight of the relevant material.

6. An orientation film according to claim 4, wherein the organopolysiloxane is polysiloxane that contains therein a fluoroalkyl group and is the one that is a hydrolytic condensate or co-hydrolytic condensate of one, or two or more, kinds of silicon compounds each of which is expressed by YₙSiX₍₄₋ₙ₎ (where Y represents an alkyl group, fluoroalkyl group, vinyl group, amino group, phenyl group, or epoxy group; X represents an alkoxyl group or halogen; and n represents an integer of from 0 to 3 inclusive.).

7. An orientation film according to claim 4, wherein the polyimide is the one that is prepared by causing reaction and polymerization of at least a tetracarboxylic acid component and a diamine component containing therein a linear alkyl group and thereby making this material a polyimide precursor containing therein a linear alkyl group and thereby imidizing the precursor.

8. A method of manufacturing an orientation film, comprising an orientation film-forming process for forming an orientation film on a substrate, and a pattern-forming process for forming with respect to the surface of the orientation film a pattern including a water-repellent region and a hydrophilic region that is a region where the angle of contact with water is smaller than that in the water-repellent region.

9. A method of manufacturing an orientation film according to claim 8, wherein the orientation film formed on the substrate is a change-in-wettability layer the wettability on whose surface changes due to the action of photocatalyst; and the pattern-forming process comprises:
a photocatalyst-containing layer side substrate-preparing process for preparing a photocatalyst-containing layer side substrate that has a photocatalyst-containing layer containing therein photocatalyst and a base material member; and
a photocatalyst treatment process for, after disposing the photocatalyst-containing layer and the change-in-wettability layer in the way that the gap therebetween becomes 200 μm or less, radiating light energy from a prescribed direction onto the resulting mass to thereby form a pattern, including a hydrophilic region and a water-repellent region, with respect to the surface of the change-in-wettability layer.

10. A method of manufacturing an orientation film according to claim 9, wherein the photocatalyst-containing layer side substrate comprises a base material member and a photocatalyst-containing layer that has formed, on the substrate, into a pattern configuration.

11. A method of manufacturing an orientation film according to claim 9, wherein the photocatalyst-containing layer side substrate that is prepared in the photocatalyst-containing layer side substrate-preparing process comprises a base material member, a photocatalyst-containing layer formed on the substrate, and a photocatalyst-containing layer side light-shielding portion formed into a patter configuration; and
the radiation of the energy in the pattern-forming process is performed from the photocatalyst-containing layer side substrate.

12. A method of manufacturing an orientation film according to claim 11, wherein, in the photocatalyst-containing layer side substrate, the photocatalyst-containing layer side light-shielding portion is formed into a pattern configuration on the base material member; and, further, on the light-shielding portion, there is formed the photocatalyst-containing layer.

13. A method of manufacturing an orientation film according to claim 11, wherein, in the photocatalyst-containing layer side substrate, the photocatalyst-containing layer is formed on the base material member and, on this photocatalyst-containing layer, the photocatalyst-containing layer side light-shielding portion is formed into a pattern configuration.

14. A method of manufacturing an orientation film according to claim 9, wherein the photocatalyst-containing layer is a layer that consists of photocatalyst.

15. A method of manufacturing an orientation film according to claim 14, wherein the photocatalyst-containing layer is a layer that is prepared by forming photocatalyst onto the base material member, as a film, by a vacuum film-making technique.

16. A method of manufacturing an orientation film according to claim 9, wherein the photocatalyst-containing layer is a layer that has photocatalyst and a binder.

17. An orientation film-equipped substrate comprising a substrate, and an orientation film that is formed on the substrate and that has on its surface on a side where a liquid crystal layer is contacted therewith a pattern including a water-repellent region and a hydrophilic region that is a region where the angle of contact with water is smaller than that in the water-repellent region.

18. An orientation film-equipped substrate according to claim 17, wherein the liquid crystal layer is disposed on a side where the surface of the orientation film is located.

19. An orientation film-equipped substrate according to claim 18, wherein the substrate has formed on its surface a colored layer; and on the surface of the colored layer there is formed a transparent electrode layer; and on the transparent electrode layer there is formed the orientation film.

20. A liquid crystal display device comprising:
a color filter side substrate that has a first substrate, a colored layer that is formed on the first substrate, a transparent electrode layer formed on the colored layer, and an orientation film that is formed on the transparent electrode layer and that has on its surface on a side where a liquid crystal layer is contacted therewith a pattern including a water-repellent region and a hydrophilic region that is a region where the angle of contact with water is smaller than that in the water-repellent region, and
an opposing substrate that has a second substrate, a transparent electrode layer formed on the second substrate, and an orientation film that is formed on the surface of the transparent electrode layer and that has on its surface on a side where a liquid crystal layer is contacted therewith a pattern including a water-repellent region and a hydrophilic region that is a region where the angle of contact with water is smaller than that in the water-repellent region,
whereby the orientation film of the color filter side substrate and the orientation film of the opposing substrate are disposed in the way they oppose each other; and
liquid crystal is sealed into between the two orientation films.
